(19) United States
(12) Patent Application Publication
(10) Pub. No.: US 2011/0062377 A1
(43) Pub. Date: Mar. 17, 2011

(54) Clarification of water and wastewater

(75) Inventor: Richard Alan Haase, Missouri City, TX (US)

(73) Assignee: ClearValue Technologies, Inc., Missouri City, TX (US)

(21) Appl. No.: 12/799,504

(22) Filed: Jun. 3, 2010

Related U.S. Application Data
(62) Division of application No. 10/413,849, filed on Apr. 15, 2003.
Application No. 10/413,849 is a continuation of application No. 09/675,695, filed on Sep. 29, 2000, now abandoned.
Application No. 09/675,695 is a continuation-in-part of application No. 09/343,616, filed on Jun. 30, 1999, now abandoned.
Application No. 09/343,616 is a continuation-in-part of application No. 09/140,203, filed on Aug. 12, 1998, now Pat. No. 6,120,690.
Application No. 09/140,203 is a continuation-in-part of application No. 08/931,167, filed on Sep. 16, 1997, now abandoned.

(30) Foreign Application Priority Data
Aug. 12, 1999 (US) PCT/US99/18338

(51) Int. Cl. C02F 5/12

(52) U.S. Cl. 252/181; 252/180

(57) ABSTRACT

A process and method for liquid-solid separation in raw water by chemical treatment, comprising adding into the water, separately or together, an effective amount of at least one aluminum polymer with an effective amount of an ammonium polymer, including at least one medium, high, or very high molecular weight ammonium polymer, to clarify said raw water to a settled turbidity standard, and including methods for blending and storing solution polymers.

This divisional application claims priority based upon: U.S. Ser. No. 10/413,849 filed Apr. 15, 2003; as well as, U.S. Ser. No. 09/675,695 filed Sep. 29, 2000; PCT US99/18338 filed on Aug. 12, 1999; U.S. Ser. No. 09/343,616 filed on Jun. 30, 1999, U.S. Ser. No. 09/140,203 filed on Aug. 12, 1998 and, the parent application, U.S. Ser. No. 08/931,167 filed Sep. 16, 1997. U.S. Ser. No. 09/675,695; PCT US99/18338; U.S. Ser. No. 09/343,616 and U.S. Ser. No. 08/931,167 are abandoned. U.S. Ser. No. 10/413,849 is pending. U.S. Ser. No. 09/140,203 resulted in U.S. Pat. No. 6,120,690.

### FIELD OF THE INVENTION

This invention relates to processes and improved processes for clarifying waters and wastewaters (raw waters), thereby removing organic and inorganic contaminants from said raw waters. In the examples below, aluminum polymers (AP) such as poly-aluminum hydroxychloride, poly-aluminum chloride, sulfated polyaluminum hydroxy chloride and poly-aluminum siloxane sulfate are combined with a medium (M), high (H) and/or very high (VH) molecular weight (MW) ammonium polymers (AmP), such as di-allyl di-methyl ammonium chloride (DADMAC), epi-chlorohydrin di-methylamine (Epi-DMA) and/or polymers based upon amino-methacrylate polyacrylamide (PA) chemistry, to significantly improve liquid-solid separation in said raw waters.

### DESCRIPTION OF THE RELATED ART

The parent application, a PCT, three continuation-in-part applications and one continuation application referenced above are herein incorporated by reference in their entirety. Providing, however, definitions and terminology established herein will govern the meaning of terms herein and below to the extent that there is any inconsistency.

In the following, the below definitions will be utilized:
Low molecular weight (L MW): 20K-250 K (20 to 250 cps @20% active in water and 40 to 1,000 cps @50% active in water)
Medium molecular weight (M MW): 500K-1,000 K (500 to 1,000 cps @20% active in water and 2,000 to 5,000 cps @50% active in water)
High molecular weight (H MW): 1000K-5,000 K (1,000 to 5,000 cps @20% active in water and >5,000 cps @50% active in water)
Very high molecular weight (VH MW): >5,000 K (defined by individual intrinsic viscosity)

In recent years, the problem of clarifying, cleaning, waters and wastewaters has become more acute due to increasing population and increasing industrial activity. Numerous solutions have been developed for treating raw waters. (The term “raw water”, which is used in the industry and is the technical term for describing contaminant-containing water, is used hereafter to refer to any water or wastewater that requires treatment, including for example, industrial, agricultural, domestic and potable water.) One aspect of cleaning raw water is the separation of solids from the liquid water, clarification. Although separation practices have been known for hundreds of years, various new processes, devices and materials have been suggested during the past decades for clarification, a separation of solids from water.

Clarification units (clarifiers), centrifuges and flotation units are among numerous devices that are used to provide said liquid-solid separation. In general, clarifiers are used to separate inorganic and organic contaminants that are heavier than water (i.e., specific gravity >1.0) and flotation units separate contaminants lighter than water (specific gravity <1.0). A centrifuge may be designed to remove either; a staged centrifuge system may be designed to remove both. In all cases, chemicals are added during coagulation and often during coagulation and flocculation to the raw water to separate insoluble solid contaminants from the raw water.

In a clarifier, floc settles in the bottom portion of said clarifier, wherein the floc is removed. Floc settling velocity is proportional to the square of the floc diameter (Stoke's Law of Liquid-Solid Separation); therefore, floc size can be a direct determinant of plant production capability.

Two stages exist during chemical treatment, coagulation and flocculation. Coagulation is the stage wherein neutralized insoluble precipitates, known as microfloc, are formed upon addition and mixing of a coagulant in the raw water. Known coagulants include AP, iron salts (IS) and aluminum salts (AS). Final water quality is very dependent on the effectiveness of microflocculation in coagulation. Next, flocculation is a stage wherein the neutralized insoluble microfloc precipitates agglomerate into macrofloc, larger floc particles. Depending upon the equipment utilized, the raw water and the chemical(s), microflocculation and macroflocculation can occur in the same equipment. Whether clarifiers or flotation units are used, a common feature of raw water coagulation/flocculation is the stage(s) wherein coagulation and flocculation occur. After flocculation, the macrofloc is removed from the water; macrofloc is removed by settling or flotation prior to filtration or storage of the separated water. If a filter is used, floc may accumulate on the filter. From time to time the filter must be washed or disposed of

Polymeric quaternized ammonium polymers (also known as ionene polymers or polyquats), containing chlorides or bromides as anions, have been used for cleaning and clarification of raw waters. It is known that the usage of a L MW quaternized AmP can reduce the amount of AS or IS necessary to remove turbidity. In the past decade, blends of a L MW AmP with an AP have been formulated in order to enhance efficiency of the AP.

It has been known to use an anionic PA as an aide to “hold down clarifier bed” by creating a large floc. It has also been known to use anionic PA as an aid to cause flotation in air flotation applications. What has not been practiced before, however, is to add a PA with an AP in the coagulation process.

In both clarifiers and in flotation units, chemicals play an essential role. AS, such as aluminum sulfate and aluminum chloride, have been used for decades as chemicals to clean water. In recent years, AP, such as aluminum chlorohydrate, poly-aluminum chloride, sulfated polyaluminum hydroxy chloride and poly-aluminum siloxane sulfate, have also been used in chemical water treatment. Recently, the sulfated versions of AP have been employed. However, while in many applications an AP has the ability to clean water with a lower dosage than that required with an AS, AP creates a very small floc as compared to that available with an AS or an IS. Further, microflocculation with AS or IS is determined by available calcium alkalinity, as calcium in the raw water combines with sulfate in the salt to form calcium sulfate; therefore, microfloc performance varies with available calcium and microfloc performance with an AS or IS, as well as an AP, is fueled by calcium alkalinity. Since microfloc chemical sites are critical in the chemical cleaning of the raw water, it is well known to a person skilled in the art of water treatment that a significantly greater chemical dosage is needed for the clarification of raw water with low calcium based alkalinity than for the clarification of water with a higher calcium based alkalinity. Water having a “low alkalinity” will be used herein to refer to water with an alkalinity of less than 50 parts per million (ppm). Water having a “high alkalinity” will refer to water with alkalinity of equal to or greater than 100 ppm. Water having an alkalinity of greater than 50 ppm and less than 100 ppm will be referred to as “moderate alkalinity” water. While the chemicals specified in this invention are especially effective in low alkalinity waters, it is not intended that their use be so restricted. In fact, the instant chemicals are useful in all raw waters.

In addition to water alkalinity, water turbidity can play a role in the cleaning of raw waters. The turbidity of water refers to the solids concentration in the water (on a weight basis, wherein an NTU, nephelometic unit, is approximately 1 mg/L). Low turbidity raw water will be used herein to refer to approximately 20 NTU or less. “Moderate turbidity” waters will refer to approximately 20 to 150 NTU. High turbidity will refer to over 150 NTU (see FIG. 1).

Pre-oxidation, such as ozonation, chlorination, chloramination and chlorine dioxide, are known and used to assist salts, to fuel, the formation of microfloc, thereby lowing the required salt dosage.

High alkalinity raw waters have alkalinity levels that are high enough to fuel coagulation with AS or IS under almost all operating conditions; high alkalinity water may even require the plant to decrease (rather than increase) the alkalinity level (this is performed with lime softening). Moderate alkalinity waters contain enough alkalinity to allow complete coagulation under most operating conditions. Low alkalinity waters have an alkalinity level that is so low as to limit the amount or type of a salt coagulant that can be effectively added. Thus, low alkalinity raw waters are the most difficult to treat without having to resort to independently raising the alkalinity level; this is while raising the calcium alkalinity level is a difficult to accomplish operation. It is common for plants with individual turbidity units of less than 20 NTU, and preferably less than 10 NTU, and calcium alkalinity values less than 30 ppm to add clay and/or lime to the water to facilitate chemical cleaning; however, this operation has limited success. Further, clay and/or undisolved lime must be removed with the floc and disposed. The lower the turbidity in the low alkalinity waters, the more difficult is the chemical treatment. While the chemicals specified in this invention are especially effective in low alkalinity waters, it is not intended that their use be so restricted. In fact, the instant chemicals are useful in all raw waters.

The removal of organic contaminants from raw water can be the most challenging aspect of cleaning the raw water. Organic contamination is measured by three methods, Total Organic Carbon (TOC), Dissolved Organic Carbon (DOC) and Pt Color Units. Pt Color is measured as “Apparent” when the water has no filtration prior to color measurement and “True” when the water has a 0.45 micron filtration prior to color measurement. It is known in the industry that organic contamination is much smaller in size than biological or viral contamination; therefore, the removal of TOC, DOC, Apparent or True Pt Color is more challenging than NTU removal.

TOC is understood to refer to organic molecules, compounds, not free carbon or carbon salts. TOC may consist of various organic molecules, which can be classified into, or in this invention are helpfully distinguished into, the categories of Insoluble Organic Carbon (IOC) and generally Soluble Organic Carbon (SOC). IOC molecules are generally non-polar long chain organic molecules having a length greater than or equal to approximately C4. SOC molecules are either short chain (polar or nonpolar) organic molecules or polar (short or long chain) organic molecules. For polar organic molecules, the degree of water solubility is directly related to the degree of polarity. For polar molecules, their degree of solubility is usually expressed in percentage terms. The degree of solubility of short chain non-polar organic molecules is usually expressed in terms of mg/L.

For clarity and definition, SOC is defined in this specification as previously described. SOC, in this specification, is not defined by the standard DOC industry laboratory test. Both soluble and insoluble TOC can pass through a 0.45-micron filter. True SOC is soluble or truly dissolved TOC. The Handbook of Chemistry and Physics by CRC Press is a good reference of the true water solubility of organic compounds, as well as the appropriate laboratory procedure to determine their water solubility.

Because of their insolubility, IOC can be removed via coagulation and flocculation. Being insoluble, IOC develops a negative columbic charge that allows a cationic coagulant to remove IOC from the water. In the case of the short chain and/or polar SOC, this does not happen. SOC is difficult to remove via coagulation and flocculation because of solubility. By being soluble, SOC do not develop a negative columbic charge; therefore, cationic coagulants are less able to remove SOC from the water. Furthermore, if the TOC, IOC and SOC, are small and/or low in concentration the kinetics required to bring the coagulant in contact with said TOC translates to a very high mixing energy. This kinetic requirement becomes critical when it is taken into account that TOC is measured to an accuracy of fractional ppm.

For the very difficult to treat low alkalinity, low turbidity waters, M, H and VH MW AmP has been discovered in this invention to be especially effective in fueling the coagulation process. In low alkalinity raw waters with moderate and high turbidity, the M, H and VH MW AmP has also been discovered to be effective in fueling coagulation. As the turbidity of the raw water increases, the M, H and VH MW AmP has been discovered to be effective in removing contaminants so that AP can be more effective and efficient. In high alkalinity water that has low turbidity, it has been discovered that M, H and VH MW AmP still enhance AP performance but are required in much lower percentages to fuel coagulation for optimal performance.

High alkalinity, low turbidity water is clarified most easily. Since the water alkalinity is high, the alkalinity itself helps fuel the coagulation and flocculation. Meanwhile, since the turbidity is low, much less water cleaning is required than for moderate and high turbidity waters. AS or AP alone normally perform satisfactorily and sometimes achieve the required government standards. While the technology of the instant invention will outperform AS or AP alone in high alkalinity low turbidity raw waters, this improvement is usually in cost of operation rather than in water quality performance. However, it has been found that the technology of this invention can eliminate the need for pre-chlorination or pre-ozonation. Therefore, this technology can minimize the formation of disinfection by-products during coagulation and flocculation.

Final water pH is an important parameter in water quality. In drinking water, a low pH water can present a bad taste to many individuals; in industrial applications, a low pH can cause equipment corrosion. Final water pH targets are normally between 7.5 and 9.0. Traditionally, the chemical cleaning process is performed with AS or IS. Therefore, the pH is normally lowered in the raw water during chemical cleaning to keep cations available. Often with an AS or IS the water pH is reduced to the 4.5 to 5.5 range. Low pH water will deteriorate operating equipment over time. Raising the pH back to the 7.5 to 9.0 range requires the addition of alkalinity, such as caustic or lime at considerable expense. The process of salt addition followed by caustic and/or lime addition increases plant operating cost. The salt and/or lime precipitate must be removed from the water either in clarification or in filtration. Removal is costly. Salt and lime precipitates form a small floc, termed pin-floc; this pin-floc significantly reduces filter run time “hours” increasing filter operating expense. Also, salt and lime precipitates settle in the clarifier or flotation unit or centrifuge creating a hydroxide sludge that is high in water content. Salt and/or salt/lime sludge is approximately 99% water. Disposal of this sludge can be a significant operating cost.

When AP, poly-aluminum hydroxychloride (Al_{X}OH_{Y}Cl_{Z} or its similar chemistries), react to chemically clean raw water, hydroxyl groups are released into the raw waters. Chemical treatment with AP in general normally maintains or slightly increases the raw water pH. Therefore, treatment with AP can save cost due to a reduction in the amount of either caustic or lime required to raise the pH. However, the smaller floc size of an AP or of AP in combination with L MW AmP(s) can be a limiting factor to the successful application of AP.

Traditionally in these applications, DADMAC and Epi-DMA were sold at a molecular weight from about 20,000 to about 250,000 which correlate to a viscosity in the range of about 20 cps to about 250 cps at a concentration of about 20% in water and correlate to a viscosity of about 50 cps to about 1,000 cps at a concentration of about 50% in water. While the higher molecular weight DADMAC and Epi-DMA were available, their use was limited and reserved for other applications.

Many patents relating to water treatment are mostly specialized and particularly protect a limited area. For example, some patents are solely oriented towards removal of organic (but not inorganic) contaminants from water. (Pohl, U.S. Pat. No. 5,262,059, issued on Nov. 16, 1993, patents a method of removing organic contaminants from raw waters that contain an undesired liquid organic contaminant such as an organic solvent. Box, Jr. et al, U.S. Pat. No. 4,268,399, issued on May 19, 1981, patent a process for purification of organically polluted water using a zinc titanate catalyst under oxidizing conditions. McCarthy et al, U.S. Pat. No. 4,115,264, issued on Sep. 19, 1978, patent a method of purifying organically polluted water containing negligible amounts of alkali metal by contacting the polluted water with an oxygen-containing gas and a catalyst effective to promote such liquid phase oxidation. Box, Jr. et al, U.S. Pat. No. 3,823,088, issued on Jul. 9, 1974, patent a method of purifying organically polluted water by contacting the polluted water with a catalyst comprising zinc aluminate promoted with at least one metal active for initiating oxidative reactions in the liquid or gaseous phase under oxidizing conditions. Ritter, U.S. Pat. No. 5,474,703, issued on Dec. 12, 1995, described a method for clarifying bodies of water and eliminating algal bloom caused by planktonic algae using a flocculating agent prepared in an aqueous solution containing a combination of monomeric or polymeric aluminum salts and a polybasic carboxylic acid.

Hassick, et al, U.S. Pat. No. 4,746,457, issued on May 24, 1988, described the use of aluminum chloride/water soluble cationic polymer compositions having inorganic polymer activity ratios of at least 5:1 and preferably 20:1 to 100:1. Hassick et al, U.S. Pat. No. 4,800,039, issued on Jan. 24, 1989, described the use of poly-aluminum hydroxychloride/water soluble cationic polymer compositions having inorganic:polymer ratios of at least 5:1 and preferably 20:1 for clarifying waters with low turbidity and moderate and high alkalinity. Kvant et al., U.S. Pat. No. 5,182,094, issued on Jan. 26, 1993, claimed a process for the preparation of polyaluminum hydroxide complexes using aluminum compounds. FIGS. 10 and 11 illustrate comparison testing against Hassick's teachings.

The above-listed patents and many other similar inventions have been developed, of which still exist in the market. Although many different issues have been solved by these previously-existing and presently-existing purification and clarification processes and materials, there still remains significant room for improvement in the area of liquid-solid separation of raw waters for industrial and municipal purposes. There remains a need for improved materials and processes for the separation of solids from raw waters.

The timing of the instant invention is significant since presently the USEPA is requiring a lowering of drinking water final turbidity targets (i.e., turbidity of filtered water), thus requiring a lowering of drinking water turbidity targets after clarification prior to filtration, as well as after filtration. Traditionally, filtered water turbidity targets were 0.5 NTU and settled water turbidity targets were 5.0 NTU. In 1999, the new standards for the turbidity of filtered water are 0.3 NTU, with 0.10 NTU to be achieved in 3 to 5 years as indicated in pp. 100-101, Section 7.3.1 of the 1998 Edition of the EPA Handbook, entitled “Optimizing Water Treatment Plant Performance

Using the Composite Correction Program,” which provides required government regulations for water treatment. The filtered water turbidity target of less than 0.10 NTU corresponds to a settled water turbidity target of approximately 1 NTU. In many instances the traditional salt and polymer technology does not provide a chemical capability or an economical chemical pathway to water production for filtered water turbidity of less than 0.10 NTU.

The new NTU targets are being set to provide consumers with drinking water that is sufficiently free of microbial pathogens to prevent waterborne disease. During the past 20 years, the most common suspected causes of waterborne disease outbreaks were the protozoan parasites Giardia lamblia and Cryptosporidium parvum as stated in Safe Drinking Water Regulations, Federal Register, 63 FR 69477-69521, published on Dec. 16, 1998, referred to as “SDWR”. Giardia and Cryptosporidium may cause extended illnesses, sometimes lasting months or longer, in otherwise healthy individuals (SDWR, p. 9 of 85). Potential annual benefits that can be gained by removing Cryptosporidium from drinking water are shown in SDWR, p. 49 of 85. Although disinfection requirements have been developed for inactivation of Giardia cysts, inactivation of Cryptosporidium is currently being investigated by the water industry and research institutes. EPA has a particular concern regarding drinking water exposure to Cryptosporidium, because there is no effective therapeutic drug to cure the disease (SDWR p. 10 of 85). As of Feb. 16, 1999, the government has established regulations (referred to as the Interim Enhanced Surface Water Treatment Rule (IESWTR)) regarding the new requirements for maximal resulting turbidity of settled water and filtered water in order to improve control of microbial pathogens, particularly Cryptosporidium. The IESWTR applies to public water systems that use surface water or ground water under the direct influence of surface water (GWUDI-SDWR, p. 2 of 85). Pilot study work showed that when treatment conditions were optimized for turbidity and particle removal, very effective removal of both Cryptosporidium and Giardia was observed (EPA Handbook, p. 9). Under the conditions tested in the pilot study work, meeting a filter effluent turbidity (i.e., filtered water turbidity) of 0.10 NTU maximum (which corresponds to settled water turbidity of approximately 1 NTU) was indicative of treatment performance producing the most effective cyst and oocyst removal (EPA Handbook, p. 9). Another pilot study and full-scale plant work demonstrated that consistent removal rates of Giardia and Cryptosporidium were achieved when the treatment plant was producing filtered water of consistently low turbidity (0.1-0.2 NTU), as stated in EPA Handbook, p. 9. Pilot study work has shown that a small difference in filtered water turbidity (from 0.10 NTU or less to between 0.10 and 0.30 NTU), produces a large difference in cyst and oocyst removal. (EPA Handbook, p. 9). In addition, filter plant performance evaluations conducted at filtration plants have shown that when filter effluent turbidity was less than or equal to 0.20 NTU, 60% of plants were given an acceptable rating (versus 11% at 0.30 NTU), once more indicating the benefit of lowering filtered water (and, thus, settled water) turbidity (EPA Handbook, p. 10). Therefore, an extensive amount of research and field work results support a filtered water maximum turbidity goal of 0.10 NTU maximum (and, thus, a settled water maximum turbidity goal of approximately 1 NTU). Based on such test results and regulations, the required settled water turbidity is aimed to be approximately 1 NTU and the present invention is based upon such goals.

In addition, five years ago, there were no demands for water production facilities for either color or Total Organic Carbon (TOC) removal and there were no limits on the soluble aluminum concentration remaining in the filtered water. Removal of color from raw water historically has been accomplished by either pretreatment or enhanced treatment with chlorine, by treatment with Granular Activated Carbon (GAC) or by overtreatment with AS. Recently, removal of color has been accomplished with ozonation.

Pretreatment or enhanced treatment of the raw water with an oxidant creates disinfection by-products. Chlorine creates tri-halo-methanes (THM) and halo-acetic acids (HAA). THMs are known carcinogens and HAAs are known teratogens. Chloramination is known to create nitrosamines, which are very carcinogenic. Until recently, many water treatment plants were still pre-chlorinating. At the present, there are THM and HAA regulations that nearly eliminate pre-chlorination activities, as stated on p. 15 of 146 of National Primary Drinking Water Regulations: Disinfectants and Disinfection Byproducts, Federal Register, 63 FR 69389-69476, published on Dec. 16, 1998, referred to as “NPDWR”. The maximum contaminant level goal (MCLG) of THM or HAA is 0.06 ppm, i.e., 60 ppb. To stay within allowable THM and HAA guidelines (60 ppb), water production facilities have stopped pre-chlorination and only perform post-clarifier/pre-filter or post-filter chlorination. Therefore, the capability of improving settled water and filtered water turbidities, TOC and color removal by pre-chlorination has been effectively outlawed by default.

Treatment with GAC is very expensive.

Treatment with ozone is very expensive. Very recently, ozonation has been scrutinized for formation of a new type of disinfection byproducts: glycols, aldehydes, ketones and acids.

In addition, treatment with alum leads to the existence of soluble aluminum in the final water product. Aluminum is a neurotoxin, linked to many neurological diseases, such as Alzheimer's, Parkinson's, Bi-Polar disorders, Dementia, etc. Therefore, a limit of 0.20 ppm aluminum content is being imposed as stated in “CH-290 Water Hygiene,” published by the Texas Natural Resource Conservation Commission (“TNRCC”), Feb. 2, 1999, pp. 29-30. Epidemiological research since 1995 has indicated that the MCL, maximum concentration limit, for aluminum should be 0.05 mg/L in drinking water. Application of such limits effectively eliminates treatment with aluminum as an option in drinking water clarification systems.

In the IESWTR, the government requires that all public water systems using conventional filtration, regardless of size, are to be filtered sufficiently to remove specified percentages of organic materials (measured as TOC) that may react with disinfectants to form disinfection byproducts (p. 15 of 146 of WPDWR). Removal of such specified percentages of organic materials, without using chlorine, GAC, or alum can be achieved through treatment techniques that also enhance coagulation and softening.

Based on the government regulations, certain removal percentages of TOC by enhanced coagulation and softening of raw waters have been established. The required removal percentages of TOC depend upon the raw water TOC and alkalinity, as demonstrated in FIG. 2.

Systems practicing enhanced (lime and/or caustic) softening must meet the TOC removal requirements of the last column on the right. Since THM and HAA concentrations are related to water TOC (more accurately SOC), the lower the resulting TOC (SOC), the lower is the resulting THM or HAA concentration. The long term goal of the guidelines is to reduce TOC to less than 2.0 mg/L. Specific ultraviolet absorbance (SUVA) is an indicator of the treatability of disinfection byproducts precursors that can be removed. SUVA is defined as the UV-254 measurement (measured in m⁻¹), divided by the dissolved organic carbon (DOC) concentration (measured in mg/L or ppm). Meanwhile, a maximum color content for settled and filtered water is established by the government (as stated on p. 30 of CH-290 Water Hygiene). A color content of at most 15 standard color units (15 True Pt Color Units) in filtered water must be achieved.

From different angles and different directions, a conclusion is reached that the lower the turbidity, the color content, the aluminum content and the TOC of the settled water, the healthier is the filtered water. Based on such facts, the government has presently imposed: a required filtered water turbidity goal of 0.3 NTU and is presently aiming towards establishing a required filtered water turbidity goal of 0.10 NTU, TOC removal guidelines, final THM and HAA concentrations, along with maximum aluminum concentrations.

### SUMMARY OF THE INVENTION

Aluminum polymer (AP) is used herein and below to refer to an aluminum polymer or polyaluminum composition such as aluminum chlorohydrate, aluminum hydroxychloride, polyaluminum chloride, polyaluminum hydroxysulfate, polyaluminum hydroxy chlorosulfate, polyaluminum chlorosulfate calcium chloride, a polyaluminum hydroxy “metal” chloride and/or sulfate, or a polyaluminum “metal” chloride and/or sulfate, and the like.

Medium, high or very high molecular weight AmP (M, H or VH MW AmP) can be M or H MW DADMAC, M or H MW Epi-DMA, or M, H or VH MW PA. VH MW DADMAC and/or Epi-DMA do not exist at this time. Off-the-shelf cationic PA is actually a VH MW AmP. It is reasonable to believe that a M MW and a H MW PA would perform similarly to the respective M MW and H MW DADMAC and/or Epi-DMA. A H or VH MW AmP should be understood to include H MW PA or VH MW PA. M MW is included because those of skill in the art will realize, and tests indicate, that in most circumstances, a M MW AmP will perform equivalent or nearly equivalent to a H or a VH MW AmP. That is, the result could meet industry standards.

The optimal M, H or VH MW AmP choice in a given circumstance may depend on the chemistry of the raw water. The combination of AP and AmP may be further enhanced by blending the AP with an AS. The AmP may be enhanced by blending with another M, H or VH MW AmP and/or with a L MW AmP, such as DADMAC or Epi-DMA.

Due to the nature of water chemistry, as it is understood by those knowledgeable in the art, those known as water technologists, successful and optimal coagulants and/or chemical treatment for raw water can only be determined by testing on the raw water. The industry established test is the jar test. The jar test is a reliable and established method of determining an optimal and successful coagulant and/or chemical treatment when the test has been properly designed to match plant equipment constraints.

The invention herein disclosed is valuable for all raw waters. It should be understood, however, that not all possible individual combinations of AP and AmP (See FIG. 9 for various illustrative CV products) would perform equally, optimally and/or as successfully in all raw waters. As individuals have individual fingerprints, raw waters are chemically unique in their respective contaminants, constituents and/or properties. Thus, water technologists know that testing is required to determine the optimal and successful coagulant for a specific raw water-equipment combination.

The attached blend combinations of the CV 1700 and CV 1900 Series, listed in FIG. 8, reveal many combinations for this chemistry. As one tests different raw waters and follows the chemical and/or blending guidelines provided by this technology, one may determine other useful combinations that are not listed in FIG. 8 yet are optimal and/or successful in a raw water. These varying species are intended to be covered under the invention as disclosed herein.

A primary object of the invention is to devise an effective, efficient and economically feasible process for separating solids from raw waters, such that the treated waters meet or exceed local, state and/or federal guidelines.

A further object of the invention is to devise an economically feasible process for treating raw waters containing organic and/or inorganic contaminants.

A further object of this invention is to devise an efficient and effective chemical process of coagulation and flocculation that does not require pre-oxidative treatment, thereby eliminating the formation of disinfection byproducts in coagulation.

Yet another object of this invention is to devise a process for treating raw waters that requires a minimum amount of treatment chemicals.

Still another object of this invention is to devise a process for treating raw waters: with low alkalinity and low, moderate and high turbidity; with moderate alkalinity and low, moderate and high turbidity; and with high alkalinity and low, moderate and high turbidity to achieve a settled water turbidity of approximately 1 NTU or less.

An additional object of this invention is to devise a process for treating raw waters, such that equipment investment, operating cost and operating capital that are needed in the treatment process are minimized.

A yet further object of this invention is to provide a process for treating raw waters, such that reduction of color content, turbidity, total organic carbon and aluminum content are enhanced and simplified.

Additional objects and advantages of the invention will be set forth in part in a detailed description which follows, and in part will be obvious from the description, or may be learned by practice of the invention.

The present invention provides a process for chemical treatment of water and wastewater (referred to throughout the application as “raw water”) to achieve clarification. Effective amounts of an AP (defined above as an aluminum polymer or polyaluminum composition such as: aluminum chlorohydrate, aluminum hydroxychloride, polyaluminum chloride, polyaluminum hydroxysulfate, polyaluminum hydroxy chlorosulfate, polyaluminum chlorosulfate calcium chloride, any polyaluminum hydroxy “metal” chloride and/or sulfate, any polyaluminum “metal” chloride and/or sulfate and the like) and possibly an AS, such as aluminum chloride and the like, are combined with at least one of: a M, H, and/or VH MW AmP such as DADMAC, Epi-DMA and the like as well as cationic and non-ionic PA, either prior to storage at a water production facility or during a chemical cleaning process of the water production facility, to clarify the raw water and to substantially reduce, and even often remove, organic and/or inorganic contaminants. As defined herein the M MW AmP has a MW of greater than approximately 500,000 and less than 1,000,000 as measured by having a viscosity greater than about 500 and less than about 1,000 cps at a concentration of approximately 20% in water. H MW AmP is defined as 1,000,000 to 5,000,000 MW measured as about 1,000 to about 5,000 cps at a concentration of approximately 20% in water. VH MW AmP is defined as greater than 5,000,000 MW measured as greater than about 5,000 cps at a concentration of approximately 20% in water and specifically measured by intrinsic viscosity. L MW AmP has a MW ranging from 20,000 to 250,000 as measured by having a viscosity of about 20 to about 250 cps at a concentration of approximately 20% in water. Since Epi-DMA is normally 50% active, L MW Epi-DMA has a MW ranging from 20,000 to 250,000 as measured by having a viscosity of about 40 to about 1,000 cps at a concentration of approximately 50% in water. Further, M MW Epi-DMA can be correlated to have a MW ranging from 500,000 to 1,000,000 measured by having a viscosity of about 2000 to about 5000 cps at a concentration of approximately 50% in water and 1 million to 5 million measured by having a viscosity of about 1,000 to about 5,000 cps at a concentration of approximately 20% in water. PA may be cationic, non-ionic or anionic, the selection further depending on the raw water. Cationic PA, AmP, are preferably quaternized, but not necessarily so. Anionic PA should be added separately.

Preferred cationic monomers for PA are dialkylaminoalkyl (meth)-acrylates and-acrylamides, generally as acid addition or quaternary ammonium salts, and diallyl dialkyl ammonium halides. The preferred acrylates and methacrylates are preferably di-C₁₋₄ alkylaminoethyl(meth) acrylates and the preferred acrylamides are di-C₁₋₄ alkylaminopropyl (meth)acrylamides, in particular dimethylaminoethyl (meth)acrylate and dimethylaminopropyl (meth)acrylamide (with the respective acrylate and the respective acrylate and methacrylamide compounds being particularly preferred) as acid addition and quaternary ammonium salts. For most purposes the most suitable cationic monomer is a diallyl dialkyl quaternary salt, preferably dimethyl ammonium chloride. Generally a single cationic monomer is used, but if desired a copolymer may be formed, for instance from diallyl dimethyl ammonium chloride and dimethylaminopropyl methacrylamide salt, generally with the latter in a minor proportion.

Instead of forming the coagulant polymer by addition polymerization of ethylenically unsaturated monomers, any other known ionic coagulant polymers can be used. For instance suitable polymers are polyethylene imine and polyamines, e.g., as made by condensation of epichlorhydrin with an amine. Other polymers include aminomethylolated polyacrylamide (free base or quaternary or acid salt), poly (acryloxyethyltrimethylammonium chloride), poly (2-hydroxypropyl-1-N-methylammonium chloride), poly (2-hydroxy-propyl-1,1-N-dimethylammonium chloride, poly (acryloyloxyethyl diethyl methyl ammonium chloride and poly (2-vinylimidazolinum bisulphate). Mannich polymers may be used; however, stability is normally a concern.

The present invention further provides a process for contamination reduction that combines an AP or an AP in combination with an AS with M, H or VH MW AmP. PA is to be added along with the other components as part of the coagulation stage. PA is preferably a part of a blend in combination with AP or AP with AS. The process may be further enhanced by adding a L MW DADMAC and/or a L MW Epi-DMA. The addition of an AS, such as aluminum chloride, can provide enhanced organic removal, while the addition of a L MW Epi-DMA and/or a L MW DADMAC can increase the effectiveness of turbidity removal. A blend of a M and/or a H and/or a VH MW AmP with a L MW DADMAC and/or a L MW Epi-DMA with at least one AP and/or an AP and an AS has proven satisfactory.

The invention also relates to methods of blending and storing the preferred AP/AmP chemicals.

It is to be understood that the descriptions of this invention are exemplary and explanatory, but are not restrictive, of the invention. Other objects and advantages of this invention will become apparent from the following specification and from any accompanying charts, tables and examples.

### BRIEF DESCRIPTION OF THE DRAWINGS

FIG. 1 is a graph demonstrating ranges of alkalinity and turbidity, as defined in this invention.

FIG. 2 demonstrates the relationship between removal percentages of TOC relative to raw water TOC and alkalinity.

FIG. 3 shows test results for water of very low alkalinity with low turbidity.

FIG. 4 shows test results for raw water of very low alkalinity and moderate to high turbidity.

FIG. 5 shows test results for raw water of low alkalinity with low to high turbidity.

FIG. 6 shows test results for raw water of moderate to high alkalinity and low turbidity.

FIG. 7 shows test results for raw water of moderate to high alkalinity with moderate turbidity.

FIG. 8 shows the constituents of certain combinations of chemicals used for jar tests.

FIGS. 9, 10 and 11 show comparison results.

FIG. 12 shows the effect of modifying the molecular weight from H to M at selected sites.

### DESCRIPTION OF THE PREFERRED EMBODIMENT

Preferred embodiments of the present invention are illustrated in any charts, tables, drawings and examples that are included.

This invention uses various chemical combinations to significantly improve liquid-solid separation in raw water. (To simplify the description of the present invention, “separation” would implement complete or significant separation.) The present invention provides a process for chemically treating raw waters to achieve liquid-solids separation. The process that is presented significantly improves liquid-solids separation equipment processes that presently exist in the market.

The invention is directed toward removing turbidity from raw water to approximately 1 NTU or less.

The invention is directed toward removing IOC from raw water to approximately 2 mg/L or less.

The invention is directed toward producing water that contains less than 0.05 mg/L of aluminum.

The invention is directed toward producing clarified and filtered water that contains less than 5 True Pt Color Units.

The process of this invention for clarification of raw water by chemical treatment is focused on application of at least one of a: M or a H or a VH or any combination therein MW AmP in combination with: an AP or an AP in concert with an AS. In the instant invention, blends of the materials always include a fraction of AmP of a M, H or VH MW range, thereby providing a synergistic system that forms a microfloc and a macrofloc efficiently and effectively.

Vinyl polymers having water solubility and cationic characteristics, as described above, include modified PA, modification being made, for example, by the typical Mannich reaction products or the quaternized Mannich reaction products known to the artesan, or other vinylic polymers which use as a vinyl monomer those monomers containing functional groups which have cationic character. As an example, but not meant to be limiting on this invention, we include in these types of vinyl monomers such monomers as AETAC, APTAC, DMAEM, DMAEM DMS quat., DACHA HCl, DADMAC, DMAEA, MAPTAC, METAMS, AMPIQ, DEAEA, DEAEM, MAEAcAm, DMAEMAcAm, DEAEcAm, DEAEMAcAm, and ALA, the quaternized compounds containing the polymers, polymers containing diallyldimethylammonium chloride monomer, and the like. To be effective these additive polymers, be they condensation polymers or vinyl polymers, must have a M, H or VH MW. A preferred polymer is a condensation polymers derived from the reaction of epichlorohydrin and dimethylamine.
AETAC=Methacryloxyethyltrimethyl ammonium chloride
APTAC=Acryloxyethyltrimethyl ammonium chloride
DMAEM=Dimethylaminoethylmethacrylate
DMAEM DMS quat.=Dimethylaminoethylmethacrylate quaternized with dimethyl sulfate
DACHA HCl=Diallylcyclohexylaminehydrochloride
DADMAC=Diallyldimethylammonium chloride
DMAEA=Dimethyl aminoethyl acrylate and/or its acid salts
MAPTC=Acrylamidopropyltrimethyl ammonium chloride
METAMS=Methacrylamidopropyltrimethyl ammonium chloride
AMPIQ=1-acrylamido-4-methyl piperazine (quaternized with MeCl, MeBr, or Dimethyl Sulfate)
DEAEA=Diethylaminoethylacrylate and/or its acid salts
DEAEM=Dimethylaminoethylmethacrylate and/or its acid salts
DMAEAcAm=Dimethylaminoethylacrylamide and/or its acid salts
DMAEMAcAm=Dimethylaminoethylmethacrylamide and/or its acid salts
DEAEAcAm=Diethylaminoethylacrylamide and/or its acid salts
DEAEMAcAm=Diethylaminoethylmethacrylamide and/or its acid salts
ALA=Allyll amine

At least one M or H or VH MW AmP is added to or blended in the raw water with an AP, thereby providing a synergistic system of coagulation and flocculation. Said AP can be blended or added separately with at least one of a: M, H and VH AmP in the raw water or added to the raw water individually or with an AS, such as an alum if added individually or such as an aluminum chloride if blended, and the like. If desired, the M or H or VH MW AmP can be added with a L MW AmP, preferably such as Epi-DMA and/or DADMAC. Improved water cleaning and flocculation performance is herein observed upon using DADMAC having a molecular weight of at least about 500,000 and preferred 1,000,000 to about 5,000,000, defined as a 20% active product at viscosities of at least about 500 cps and preferred about 1,000 cps to about 5,000 cps, respectively.

At least one M or H or VH MW AmP can be added to or blended in the raw water with an AS in low or very low alkalinity water.

Combinations of the M or H or VH AmP (including of course the PA) with an AP and potentially with an AS in the present invention are aimed at significantly improving the coagulation and flocculation capability of an AP or an AP with a low molecular weight AmP. The present invention discloses combinations of a M or a H or a VH MW AmP with at least one AP or an AP/AS combination to have provided satisfactory results, even for raw unclarified water with alkalinity of less than 50 ppm while simultaneously causing the removal of algae from the raw water. A preferred embodiment is a combination of a M or a H MW DADMAC, Epi-DMA and/or a M, H or a VH MW PA with aluminum chlorohydrate (Al_{X}OH_{Y}Cl_{Z}). Combination of a M or H MW DADMAC and/or Epi-DMA with (Al_{X}OH_{Y}(SO₄)_{A}Cl_{Z}) and/or AS have also been successfully applied. Combination of a M or H MW DADMAC and/or Epi-DMA and/or H or VH MW PA with Al_{X}OH_{Y}Cl_{Z} and/or AS provide a system that cleans many raw waters much more efficiently and effectively than existing systems while simultaneously causing the removal of algae from the raw water. Improved water cleaning and flocculation performance is normally observed with a 20% active product, at viscosities greater than, 500 cps. A 20% active product at viscosities greater than 1,000 cps is preferred. A preferred embodiment is the combination of a H MW DADMAC or Epi-DMA and/or H or VH MW PA with an AP. In prior art, blends of AP with a polyquaternary amine, such as Epi-DMA, have been applied with L MW Epi-DMA, or molecular weight units of about 2,000 to 150,000. Combinations of the present application include a higher MW range of Epi-DMA and provide a system that cleans raw waters much more efficiently and effectively. In one embodiment, the clarification process comprises combining in the raw water or adding to the raw water AP or AP and AS with at least one M, H or VH MW AmP to form a flocculated suspension.

Further, combinations of at least one M, H and/or VH MW AmP with at least one L MW quatemized ammonium polymer and with at least one AP and/or AP and AS have provided acceptable results while simultaneously causing the removal of algae from the raw water. A preferred embodiment is a H MW DADMAC or Epi-DMA and/or M, H or VH MW PA with at least one AP and potentially with one AS. The AS is preferably aluminum chloride.

With embodiments of the present invention, it has been discovered that color units, turbidity units, TOC, IOC, disinfection byproducts and aluminum content are lowered more effectively and efficiently. There is improved coagulation and an increase in the size of flocs, resulting in cleaner water along with higher rates of floc settlement than rates available for flocs using the L MW AmP with AP. The increase in coagulation rate and in the floc size is particularly significant when the H MW and/or VH MW AmP is used in combination with an AP in low alkalinity and low turbidity water.

With embodiments of the present invention, it has been discovered that there is a reduced coagulant dosage required to clean the raw water, in particular to comply with new standards of settled turbidity, TOC, disinfection byproducts and soluble aluminum. In comparison to an AP, the reduction can be in the rate of about 30 to 60 percent; in comparison to an AS, the reduction can be in the rate of about 30 to 80 percent. The reduced overall dosage of the coagulant can be a determinative factor in the application of an AP, since AP's generally are much more expensive and alone create a very small floc in comparison the floc created by an AS or an IS. Even when the resulting turbidity is not significantly reduced with embodiments of the present invention, dosage and operating cost are significantly reduced.

The required amount of pH adjustment is significantly reduced with embodiments of the instant invention. Traditionally, either caustic or lime is used to accomplish this raise of final water pH. The process of salt addition followed by caustic and/or lime addition increases plant operating cost. The salt and lime precipitates must be removed from the water either in clarification or in filtration. Removal is costly. Salt and lime precipitates form a small floc, termed pin-floc, which is removed by filtration. This pin-floc significantly reduces filter run time “hours” increasing operating expense. Also, salt and lime precipitates settle in the clarifier or flotation unit or centrifuge creating a hydroxide sludge that is high in water content. Most salt and salt/lime sludges are approximately greater than 99% water. This sludge can be a significant operating cost as this sludge must be disposed. Since the higher MW AmP reduces the required amount of coagulant and allows the application of an AP, the use of the higher MW AmP can present significant cost savings to water plants.

In combination with an AP, the M, H or VH MW AmP presents significant potential chemical cost savings in the clarification of low alkalinity water. M, H and/or VH MW AmP with an AP is able to provide sites of micro-flocculation, achieving flocculation despite insufficient alkalinity and turbidity of the raw water. Thus, there is a reduction in the amount of chemicals needed for cleaning any type of raw water with the higher MW AmP(s) in combination with an AP (versus AS or AP or either in combination with L MW quaternized ammonium polymers).

Since pre-oxidation is done to assist AS and IS to perform microflocculation, the use of a M, H and/or VH MW AmP in combination with an AP or in combination with an AP and an AS can eliminate the need for pre-oxidation, thereby significantly reducing the need for oxidation in general, further reducing costs and eliminating the disinfection byproducts of oxidation. Should a pre-oxidant be required for disinfection purposes, chlorine dioxide and/or hydrogen peroxide is most preferred; while, ozone is an embodiment.

M, H and/or VH MW AmP(s) with AP make a larger floc at lower dosages than low MW AmP or L MW quaternized ammonium polymers do. Formation of a larger floc at a lower dosage is particularly beneficial in oil/water separation as would normally be accomplished in a flotation unit. By using M or H MW DADMAC and/or M or H MW Epi-DMA alone or with AP, raw algae is removed.

Algae is also removed during separation of water upon applying a H or VH MW AmP; a preferred application is a H MW DADMAC, and a herbicide. The present invention can be applied under a variety of conditions and in many different apparatus.

Blending these multi-component chemical systems is an important criterion to most users of this technology as most users of this technology either will not have the equipment for multiple chemical feed systems and/or will not be interested in controlling a multi-component chemical feed system. While prior blending is not required, prior blending is preferred.

Previous art either has been unable to blend or has had significant limitations on the blending of these chemicals. It has been generally accepted in the industry that:
Dry cationic and dry non-ionic polyacrylamides could not be blended with an AP and/or an AS and/or solution polymers such as DADMAC and Epi-DMA as the inclusion of dry polymers resulted in a lumping of the polyacrylamide known as “Fish Eyes.” This inhibition has reduced the previous combination of these chemicals to the utilization of either the emulsion form of polyacrylamides, which are only 40 to 60 percent active in a hydrocarbon solvent, or to a costly step of effecting a combination of solution polymers, such as an AP or a DADMAC or an Epi-DMA, during a polyacrylamide emulsion finishing process.
AP's and/or AS's could not be blended with DADMAC unless the catalyst for DADMAC manufacture was sodium persulfate. It was accepted that DADMAC manufactured with ammonium persulfate could not be blended with an AP as the aluminum would precipitate from solution over a relatively short period of time.
AS's and/or AP's were difficult to blend with either Epi-DMA and/or DADMAC.
AP's and AS's could not be blended together or together could not be blended with polyacrylamides, DADMAC and/or Epi-DMA.

Notwithstanding the above, it has been found that stable blends of these chemistries can be manufactured, preferably in accordance with the below guidelines:
The basicity of the final solution when blending aluminum chloride solution with A_{X}OH_{Y}Cl_{Z} is maintained less than 55% and preferably less than 45% for stability.
Termination of the Epi-DMA reaction is accomplished with an acid other than acids containing sulfur, such as sulfuric and sulfurous acid. Reactions terminated with hydrochloric acid are preferred. Subsequent blending of Epi-DMA terminated with HCl has shown excellent results when the other blending guidelines mentioned herein are followed.
DADMAC can be manufactured with either sodium persulfate or ammonium persulfate when the other blending guidelines mentioned herein are followed.

All AmP's, AP's, AS's and any dilution water are preferably blended in the following order:
1. Blend water with the required solution polymer(s),
2. Perform pH adjustment, preferably with hydrochloric acid or with any acid with an anion compatible with AP, such as HBr, etc. (Sulfur containing acids will lead to aluminum precipitation.) pH adjustment should be less than 6.0 and is preferably 4.25±0.25.
3. Blend any required AP after pH adjustment.
4. Add any required AS, excluding alum.
5. Required cationic or non-ionic polyacrylamides are added last.

Aluminum containing chemical(s) is preferably added in combination with high shear mixing.

Any required cationic or non-ionic polyacrylamide is added in combination with high shear mixing at the point of addition followed by slow mixing. Final solution viscosity is significantly affected by the addition of polyacrylamide; therefore, it is preferred to only add dry polyacrylamides to concentrations of 3% or less and emulsion polyacrylamides to concentrations of 8% or less. Once the aluminum chemical(s) is added, the addition of any basic or oxidation material is preferably avoided as addition may lead to aluminum precipitation.

Anions containing sulfur are preferably minimized or eliminated from any blend containing AP unless those anions are included during the manufacturing process of AP.

The use of any sulfated AP may eliminate the use of any AS.

Any required anionic polyacrylamide should be added separately at the point of use.

Numerous tests have been performed on the clarification process. Optimizing the clarification process has been a common goal of all the tests. The results of some of the tests run for enhancing clarification of the raw waters follow:

### Example 1

In the water production facility of Bonham, Tex., aluminum sulfate, a low molecular weight DADMAC and bentonite clay are used to produce water with a turbidity ranging from about 0.1 NTU to about 0.3 NTU. The alkalinity normally is between about 10 ppm to about 20 ppm. The raw turbidity usually ranges from about 3 NTU to about 6 NTU. The chemical dosages are normally from about 40 ppm to about 60 ppm alum, about 10 ppm bentonite clay and about 20 ppm low molecular weight DADMAC.

Jar tests were performed with a poly-aluminum chloride/aluminum chlorohydrate blend of Applicant (being 50% active) and high molecular weight DADMAC of Applicant (referred to as CV 3650, having a molecular weight greater than 1 million and being 20% active), producing water with a turbidity of about 0.7 NTU without any filtration. The chemical dosages were approximately 12 ppm by volume (12 ppm×1.36 specific gravity×0.5 concentration=8.2 ppm by weight) of the 50% active poly-aluminum chloride/aluminum chlorohydrate blend and approximately 2.5 ppm by volume (2.5 ppm×1.04 specific gravity×0.2 concentration=0.5 ppm by weight) of the 20% active high molecular weight DADMAC, with the weight ratio of the poly-aluminum chloride/aluminum chlorohydrate blend to high molecular weight DADMAC being 8.2 ppm:0.5 ppm=16.4.

### Example 2

In the water production facility of Camden, Ark., ferric sulfate is used to produce water with a turbidity of approximately 0.1 NTU. The alkalinity is normally near 10 ppm. The raw turbidity usually ranges between about 5 to about 20 (with a turbidity of less than 20 NTU being referred to as “low turbidity” and a turbidity of greater than 20 NTU being referred to as a “moderate turbidity” herein). Chemical dosages are normally about 30 ppm to about 60 ppm iron sulfate.

Jar tests were performed with a poly-aluminum chloride/aluminum chlorohydrate blend of Applicant (being 50%) active and high molecular weight DADMAC of Applicant (referred to as CV 3650, having a molecular weight greater than 1 million and being 20% active), producing water with a turbidity at approximately 0.1 NTU without any filtration. Dosages were about 6 ppm by volume (6 ppm×1.36 specific gravity×0.5 concentration=4.1 ppm by weight) of the 50% active poly-aluminum chloride/aluminum chlorohydrate blend and about 2.5 ppm by volume (2.5 ppm×1.04 specific gravity×0.2 concentration=0.5 ppm by weight) of the 20% active high molecular weight DADMAC, with the weight ratio of the poly-aluminum chloride/aluminum chlorohydrate blend to higher molecular weight DADMAC being 4.1 ppm:0.5 ppm=8.2.

Jar testing with the iron sulfate required approximately 40 ppm iron sulfate. Without using any filtration, water with a turbidity of about 1.5 NTU was recovered. Later, plant production testing revealed final water of 0.023 NTU with 7 ppm of the 50% active aluminum polymer blend and 2.0 ppm of the 20% active high molecular weight DADMAC.

Example 3

In the water production facility of Antlers, Okla., aluminum sulfate is used alone to produce water having a turbidity ranging from about 0.1 NTU to about 0.3 NTU. The alkalinity is normally less than 10 ppm. The raw turbidity normally is between about 3 NTU to about 10 NTU. The chemical dosage of alum normally ranges between about 40 ppm to about 60 ppm.

Jar tests were performed with a poly-aluminum chloride/aluminum chlorohydrate blend of Applicant (being 50% active) and high molecular weight DADMAC of Applicant (referred to as CV 3650, having a molecular weight greater than 1 million and being 20% active), producing water with a turbidity of approximately 0.6 NTU without any filtration. The dosage of the poly-aluminum chloride/aluminum chlorohydrate blend was about 8 ppm by volume (8 ppm×1.36 specific gravity×0.5 concentration=5.4 ppm by weight) and of the high molecular weight DADMAC was about 2.5 ppm by volume (2.5 ppm×1.04 specific gravity×0.2 concentration=0.5 ppm by weight). The weight ratio was 5.4/0.5=10.8.

Jar testing with the aluminum sulfate required approximately 40 ppm by weight aluminum sulfate and, without using any filtration, water with a turbidity of 1.0 NTU was recovered.

### Example 4

In the water production facility of Greenville, Tex., aluminum sulfate and a typically-used low molecular weight DADMAC are used to produce water of a turbidity of less than 0.1 NTU. The alkalinity normally ranges from about 10 ppm to about 30 ppm. The raw turbidity normally is between about 3 NTU to about 10 NTU. Chemical dosages are normally from about 40 ppm to about 60 ppm alum and about 2 ppm of the low molecular weight DADMAC.

Jar tests were performed with poly-aluminum chloride/aluminum chlorohydrate blend of Applicant (being 50% active) and high molecular weight DADMAC of Applicant (referred to as CV 3650, having a molecular weight greater than 1 million and being 20% active), producing water with a turbidity at approximately 0.4 NTU without any filtration. The dosage of the poly-aluminum chloride/aluminum chlorohydrate blend was about 8 ppm by volume (8 ppm×1.36 specific gravity×0.5 concentration=5.4 ppm by weight) and of the high molecular weight DADMAC was about 2.5 ppm by volume (2.5 ppm×1.04 specific gravity×0.2 concentration=0.5 ppm by weight), with the weight ratio of poly-aluminum chloride/aluminum chlorohydrate blend to high molecular weight DADMAC being 5.4 ppm/0.5 ppm=10.8.

Jar testing with aluminum sulfate required approximately 60 ppm aluminum sulfate and approximately 2 ppm of DADMAC and, without using filtration; water with a turbidity of approximately 0.8 NTU was recovered. In jar testing with aluminum sulfate, water pH was reduced to 6.1, while jar testing with poly-aluminum chloride/aluminum chlorohydrate blend and high molecular weight DADMAC raised water pH from 6.6 to 7.1.

### Example 5

Formosa Plastics in Point Comfort, Tex., produces about 4 to 5 million gallons per day of wastewater. In the first stage of the wastewater treatment process, dissolved air flotation units are employed to remove oils at the surface and inorganic solids are removed by rake in the bottom of these units.

A low molecular weight DADMAC, blended with aluminum chlorohydrate had been in use having turbidity/total suspended solids (NTU/TSS) removal efficiency in a range of between approximately 40 percent to approximately 50 percent. The low molecular weight DADMAC blend as added to the dissolved air flotation unit at a dosage of about 6 ppm to about 8 ppm. An anionic flocculant was added in a dosage ranging from about 1.0 ppm to about 1.5 ppm.

Fifty percent active aluminum chlorohydrate in a 60% ratio (referred to as CV 1120) and 20% active high molecular weight DADMAC in a 40% ratio of Applicant (referred to as CV 3650, having a molecular weight greater than 1 million and being 20% active), were added to the dissolved air flotation unit at concentrations ranging from about 4 ppm to about 6 ppm in concert with an anionic flocculant ranging between approximately 1.0 ppm and approximately 1.5 ppm. This product increased the dissolved air flotation unit efficiency to over about 70 percent.

### Example 6

In DeQueen, Ark., alum is used in a final clarifier to remove algae prior to wastewater discharge. Removal of total suspended solids (TSS) is a critical discharge parameter, as with all wastewater treatment facilities. The dosage of alum typically ranges from about 100 ppm to about 250 ppm. Adding approximately 3 ppm to 5 ppm of CV 3650 (high molecular weight DADMAC) causes a reduction of the required alum to less than 100 ppm, while keeping the total suspended solids less than 15 ppm.

Waste aluminum chloride (being 18% active and being obtained from a styrene production facility of Dow Chemical) was blended with high molecular weight DADMAC of Applicant (referred to as CV 3650, having a molecular weight greater than 1 million and being 20% active), in a ratio of 65:35. At dosages about 35 ppm and about 40 ppm of the blend, the plant was in permit at 6 ppm total suspended solids. (Permit is 15 ppm total suspended solids). Alum (obtained from 48% active liquid of General Chemical) alone required in excess of 200 ppm and said alum in combination with CV 3650 required 90 ppm by volume alum/4 ppm by volume CV 3650, respectively.

### Example 7

In Beaumont, Tex., alum is used in a French Pulsation Clarification System. Typical values are between 20 ppm and 25 ppm of raw alkalinity, 8 ppm of calcium, raw water turbidity units (NTU) of 40 to 60 and raw color of 40 to 80 units. Alum usage is normally 45 to 55 ppm at raw color units of 40 to 60. An anionic polyacrylamide is used in emulsion form at a dosage of 0.2 to 0.4 ppm to control pin floc carryover and floc size. As the raw color units rise, the alum usage increases such that at raw color units of 120 the alum usage is 90 to 100 ppm. The city of Beaumont normally utilizes 30 to 40 ppm of 50% caustic for pH adjustment, along with 55 ppm of caustic to pH adjust the alum sludge which would otherwise corrode the sewer line.

The optimal chemistry for Beaumont as performed in numerous jar tests is a combination of aluminum chlorohydrate of Applicant (referred to as CV 1120 and being 50% active), high molecular weight DADMAC of Applicant (referred to as CV 3650, having a molecular weigh greater than 1 million and being 20% active), low molecular weight Epi-DMA of Applicant (referred to as CV 3210 and being 50% active) and aluminum chloride (referred to as CV 1135 and being 10% active) in combination with the anionic polyacrylamide. Utilizing this chemistry, dosages of 12 to 14 ppm obtained a final filtered NTU of 0.08 along with 1 color unit. Plant operation with and jar tests with alum revealed final NTU's of 0.22 at 55 ppm. pH adjustments with alum required 32 ppm of 50% caustic where this chemistry only required 8 ppm.

Further, the higher pH values capable with this chemistry allows for the removal of manganese and taste and odor from the raw water with potassium permanganate and chlorine dioxide. Neither of these chemicals can perform with alum as the low pH value for alum removes their oxidation potential.

### Example 8

In Marshall, Tex., alum was used in a sedimentation basin system. Typical values are between 20 ppm and 25 ppm of raw alkalinity, 12 ppm of calcium, raw water turbidity units (NTU) of 5 to 8 and raw color of 40 to 200 units. Alum usage is normally 32 to 38 ppm. During periods of 200 raw color units, the city cannot maintain turbidity targets of 0.3 NTU or less. Augmentation of the alum with 1 ppm to 2 ppm of high molecular weight DADMAC of Applicant (referred to as CV 3650, having a molecular weight greater than 1 million and being 20% active), reduces final NTU's to less than 0.1 and allows the plant to stay in permit. Prior to usage of CV 3650, the plant went out of permit with high color raw water.

Jar tests with a combination of aluminum chlorohydrate of Applicant (referred to as CV 1120 and being 50% active), high molecular weight DADMAC of Applicant (referred to as CV 3650, having a molecular weight greater than 1 million and being 20% active), low molecular weight Epi-DMA of Applicant (referred to as CV 3210 and being 50% active) and aluminum chloride (referred to as CV 1135 and being 10% active) produced a settled 0.7 NTU at a dosage of 8 ppm. This compares favorably to 32 ppm alum and 2 ppm of CV 3650 obtaining 0.6 NTU in the same test.

### Example 9

In Longview, Tex., alum is used in a sedimentation basin system. Typical values are between 20 ppm and 25 ppm of raw alkalinity, 10 ppm of calcium and raw water turbidity units (NTU) of 1 to 3. Alum usage is normally 18 to 25 ppm. Settled NTU is normally 1 to 1.5. Final NTU is normally 0.15 to 0.20.

The chemistry for Longview performed in numerous jar tests is a combination of aluminum chlorohydrate of Applicant (referred to as CV 1120 and being 50% active), high molecular weight DADMAC of Applicant (referred to as CV 3650, having a molecular weight greater than 1 million and being 20% active), low molecular weight Epi-DMA of Applicant (referred to as CV 3210 and being 50% active) and high molecular weight Epi-DMA of Applicant (referred to as CV 3250 and being 50% active). This combination at dosages of 3 to 4 ppm produces 0.17 NTU settled/filtered in a jar test while alum at 18 ppm produced 0.16 NTU. The alum required a 300 percent increase in lime to pH adjust as compared to this new chemistry.

### Example 10

In Nederland, Tex., PRC 3050C is used in a solids contact clarification system. Typical raw alkalinity values are between 0 ppm and 30 ppm. Polymer usage is very dependent on the raw color which can vary from 20 to over 300. Polymer usage varies from about 15 ppm to over 70 ppm. Final NTU is normally less than 0.10.

The optimal chemistry for Nederland as performed in numerous jar tests is a combination of aluminum chlorohydrate of Applicant (referred to as CV 1120 and being 50% active) and high molecular weight of DADMAC of Applicant (Referred to as CV 3650, having a molecular weight greater than 1 million and being 20% active). This combination produced 0.6 NTU water at 10 ppm beside the current system that produced 0.8 NTU at 16 ppm, on the day tested. Testing with tannic acid found the new chemistry to significantly remove more color than the PRC 3050C. Raw water testing from the Neches River Upstream of Nederland found that water spiked with tannic acid to 120 color units had a removal to 14 color units with this chemistry while the current system only obtained 32 color units.

### Example 11

In Omaha, Nebr., a cold lime softening system is used to clarify high turbidity water from the Missouri River. Pretreatment is normally done with a typical DADMAC (having a molecular weight near 200,000 and being 20% active producing 200 cps). Usage of the high molecular weight DADMAC reduced operating dosages by over 70% while producing water at less than 0.1 NTU. The DADMAC is also used as a filter aid at this facility.

Further, at Omaha, to meet competitive bidding requirements, high molecular weight DADMAC of Applicant (referred to as CV 3670, having a molecular weight greater than 1 million and being 10% active) was delivered as 10% active at viscosities of 150 to 250 cps. The previous low molecular weight version was 20% active at 200 cps. At only 10% activity, the CV 3670 still outperformed the low molecular weight version by 25 to 30 percent in dosage.

### Example 12

In Hugo, Okla., aluminum chlorohydrate is used in a reactor clarification system. Typical raw alkalinity values are 5 to 25 ppm and the raw NTU is 3 to 20. Usage of low molecular weight Epi-DMA (being 50% active) is normally 3 to 5 ppm and usage of aluminum chlorohydrate (being 50% active) is normally 20 to 35 ppm. Final water production is normally less than 0.3 NTU. Color is not measured.

High molecular weight DADMAC of Applicant (referred to as CV 3650, having a molecular weight greater than 1 million and being 20% active) was used in concert with aluminum chlorohydrate of Applicant (referred to as CV 1120 and being 50% active). Where normal plant operation and the jar tests showed current operation to require 30 ppm of aluminum chlorohydrate in concert with 3 ppm of low molecular weight Epi-DMA, the new chemistry only required 20 ppm of CV 1120 in concert with 2 ppm of CV 3650. The old chemistry only obtained 0.7 NTU at about 40% greater chemical cost.

### Example 13

In Mena, Ark., alum is used in concert with an anionic polyacrylamide in a solids contact clarification system. Typical raw alkalinity values are 3 to 20 ppm and the raw NTU is 3 to 10. Alum usage is normally 40 to 60 ppm along with an excess of 20 ppm of 50% caustic in combination with 10 to 20 ppm of lime. The plant normally produces less than 0.3 NTU.

High molecular weight DADMAC of Applicant (referred to as CV 3650, having a molecular weight greater than 1 million and being 20% active) was used in concert with aluminum chlorohydrate (referred to as CV 1120 and being 50% active). Where normal plant operation and the jar tests showed current operation to require 40 ppm of alum, the new chemistry only required 4 ppm of CV 1120 (50% active aluminum chlorohydrate) in concert with 1.5 ppm of CV 3650 (20% active DADMAC at 2,000 cps). The new chemistry obtained 0.7 NTU in the jar test while the old chemistry only obtained 1.0 NTU at about 70% greater chemical cost. At this facility, it is very difficult to obtain a floc at all due to the combination of low alkalinity and low NTU. Therefore, large amounts of alum are normally required. However, CV 1120 and CV 3650 were able to develop a floc easily. Further testing with low molecular weight Epi-DMA (of a molecular weight of 100,000) or low molecular weight DADMAC (of a molecular weight of 200,000) showed no ability to develop a floc and clean the water.

### Example 14

In Palestine, Tex., alum is used alone in a sedimentation basin system. Typical raw alkalinity values are 20 to 50 ppm and the raw NTU is 5 to 30. The plant normally produces less than 0.1 NTU.

In jar tests, an optimum alum NTU of 0.7 was obtained. By augmenting the jar tests with 1 ppm of high molecular weight DADMAC of Applicant (referred to as CV 3670, having a molecular weight greater than 1 million and being 10% active), the alum dosage was reduced by 40% while 0.6 NTU water was produced.

### Example 15

In DeQueen, Ark., the municipal wastewater plant performs nitrification in a 40 acre pond system. From 3 to 5 times per year, this pond system has an algal bloom of blue/green algae. Blue/green algae emit a nitrogen containing polymer that is toxic to nitrifying microorganisms. Therefore, during periods of blue/green algae blooming, the plant loses its ability to nitrify, producing water laden with ammonia that is in excess of state and federal permit values.

Testing performed with high molecular weight DADMAC of Applicant (referred to as CV 3650, having a molecular weight greater than 1 million and being 20% active at 2,000 cps), in combination with Diurion (dichloro-dimethyl-phenolurea manufactured by Dupont) provided that this chemistry blend will flocculate and kill the algae while not harming the nitrosomonas or the nitrobactors. The blend put together was CV 3670 (a high molecular weight DADMAC produced by Applicant, having a molecular weight greater than 1 million and being 10% active at 200 cps) with 10 percent Diurion added by weight.

Two tests were set up: one to measure algal killing performance and one to measure nitrification effectiveness with the product blend. In each test there was a control, one container having 10 ppm of the blend and one container having 25 ppm of the blend. To test for algal growth, water samples were placed in three 5 gallon buckets. To test nitrification, water samples were placed in three 1000 ml beakers. In the beakers, nitrification performance compared to the QC Specification for CV Bio 3010XS (a blend of nitrifiers comprising nitrosomonas and nitrobacters) which is 500 mg of ammonia removed per hour per liter of nitrifiers at 100° F. For the three beakers, variance was well within testing and measurement capabilities (480 mg to 520 mg of ammonia removed/hr/liter of nitrifier). For the three 5 gallon buckets, there was complete algal kills at both 10 and 25 ppm. The control bucket had a flourishing algal bloom throughout the test. It is worth noting that at 25 ppm, the alga was flocculated as well as it was killed.

### Example 16

In Beaumont, Tex., alum is used in a French Pulsation Clarification System. Typical values are between 20 ppm and 25 ppm of raw alkalinity, 8 ppm of calcium, raw water turbidity units (NTU) of 40 to 60 and raw color of 40 to 80 units. Alum usage is normally 45 to 55 ppm at raw color units of 40 to 60. An anionic polyacrylamide is used in emulsion form at a dosage of 0.2 to 0.4 ppm to control pin floc carryover and floc size. As the raw color units rise, the alum usage increases such that at raw color units of 120 the alum usage is 90 to 100 ppm. The city of Beaumont normally utilizes 30 to 40 ppm of 50% caustic for pH adjustment.

During numerous jar tests, a combination of aluminum chlorohydrate of Applicant (referred to as CV 1120 and being 50% active), high molecular weight DADMAC of Applicant (referred to as CV 3650, having a molecular weight greater than 1 million and being 20% active) and aluminum chloride (referred to as CV 1135 and being 10% active). The blend comprises 40% CV 1120, 30% CV 1135 and 30% 3650. Utilizing this chemistry, dosages of 18 to 22 ppm obtained a final 1 micron filtered NTU of 0.2 to 0.8.

### Example 17

In Nederland, Tex., PRC 3050C is used in a solids contact clarification system. Typical low alkalinity values are between 0 ppm and 30 ppm. Polymer usage is very dependent on the raw color which can vary from 20 to over 300. Polymer usage varies from about 15 ppm to over 70 ppm. Final NTU is normally less than 0.10.

On this day operation was 32 ppm of PRC 3050C. The raw water was 45 NTU. Color was not measured. Visually, one could estimate a color of 50 to 75 standard color units. A blend of aluminum chlorohydrate of Applicant (referred to as CV 1120 and being 50% active), high molecular weight DADMAC of Applicant (referred to as CV 3650, having a molecular weight greater than 1 million and being 20% active) was prepared for a settled jar test. The preferred embodiment enclosed a blend of 60% CV 1120 and 40% CV 3650. At concentrations of 24 to 28 ppm, NTU's of 0.4 to 0.7 were obtained.

On the same day, a blend of aluminum chlorohydrate of Applicant (referred to as CV 1120 and being 50% active), high molecular weight DADMAC of Applicant (referred to as CV 3650, having a molecular weight greater than 1 million and being 20% active) and aluminum chloride (referred to as CV 1135 and being 10% active) was prepared. This combination produced a blend of 40% CV 1120, 20% 1135 and 40% CV 3650. In a settled jar test, NTU's of 0.6 were obtained at dosages of 28 to 36 ppm.

### Example 18

Marshall, Tex.—Marshall's raw water quality makes production difficult. At best:
The raw alkalinity is less than 20 ppm and often as low as 6 ppm,
The raw turbidity is 2 to 7 NTU,
The raw color varies from 40 to 300 Standard Color Units, and
The raw TOC ranges from a UV absorbency of 0.2 to 0.7 m⁻¹, and 5 to 20 ppm.

Prior to the use of CV 3650 with alum, Marshall operated with just alum and often went out of permit having a filtered water turbidity greater than 0.5 NTU. CV 3650 in conjunction with alum improved operation significantly. However, at raw color values over 200 Standard Color Units, Marshall still had difficulties.

Prior to using CV 1703, Marshall produced filtered water at a turbidity of 0.15 to 0.30 NTU under normal conditions and higher when color is a challenge. Since operation with CV 1703, Marshall has kept the filtered water turbidity under 0.08 NTU under all conditions. The settled water turbidity normally varies from 0.01 to 0.07 NTU. Marshall is obtaining 50 to 80% TOC removal with CV 1703.

### Example 19

Center has a small facility, Mill Creek, which produces 1 to 2 MGD. This facility is over 60 years old and has antiquated equipment in combination with very difficult-to-treat water. The raw water quality:
Varies in alkalinity from 10 to 25 ppm,
Varies in turbidity from 15 to 80 NTU, and
Varies in color from 30 to over 400 Standard Color Units.

Due to inadequate final water quality, during periods of high color, Center would shut this facility down. During normal operation, Center had to pre-chlorinate to produce filtered water with a turbidity of less than 0.5 NTU. Previous to usage of CV 1703, the settled water turbidities were 3 to 4.5 NTU.

Since operation with CV 1703, Center normally produces settled water turbidity of less than 1.0 NTU and always less than 1.5 NTU. Center has been able to stop pre-chlorination, producing filtered water with a turbidity of less than 0.1 NTU and has successfully treated water with a raw color of 400 Standard Color Units.

### Example 20

Nacogdoches has raw water with:
An alkalinity of 10 to 25 ppm,
A turbidity of 4 to 20 NTU, and
Color of 10 to 100 Standard Color Units.

Nacogdoches normally operates using 25 to 40 ppm of alum. During periods of the raw color exceeding 70 Standard Color Units, Nacogdoches will operate at near or slightly exceed permit.

A plant evaluation utilizing CV 1735 was held on Jun. 20 to 23, 1999. During this evaluation the water quality was:
A raw water alkalinity of 18 ppm,
A raw water turbidity of 24 NTU,
A raw water color of 56 Standard Color Units,
A settled water turbidity of 0.7 NTU,
A filtered water turbidity of 0.1 to 0.15 NTU, and
A filtered water color of 7 Standard color units.

During the evaluation, Nacogdoches operated at:
A settled water turbidity of 0.4 to 0.6 NTU,
A filtered water turbidity of 0.10 NTU,
A final color of “0” Standard Color Units, and
A dosage of 5 ppm of CV 1735.

### Example 21

In Beaumont, Tex., alum is used in a Pulsation Clarification System. Typical raw water values are between 20 ppm and 25 ppm of raw alkalinity, 8 ppm of calcium, and 40 to 60 NTU. An anionic polyacrylamide is used in emulsion form at a dosage of 0.2 to 0.4 ppm to control pin floc carryover and floc size. As the raw color units rise, the alum usage increases such that at raw color units of 120 the alum usage is 90 to 100 ppm. The City of Beaumont normally utilizes 30 to 40 ppm of 50% caustic for water pH adjustment along.

During numerous jar tests, CV 1730, a combination of 25 volume percent Al_{X}OH_{Y}Cl_{Z} being 50% active and 84% basic (CV 1120), 30 volume percent aluminum chloride being 10% Al₂O₃ (CV 1135), 30 volume percent Epi-DMA 50% active at 120 cps (CV 3210) and 15 volume percent DADMAC 20% active at 2,000 cps. CV 1730 was used with CV 6230P, a 40% active emulsion of 30% anionic polyacrylamide. CV 1730 was compared in jar tests without CV 6230 P.

In addition, CV 1120 was tested in combination with CV 3210 and CV 3650. These tests were repeated and without CV 6230P. The jar testing sequence utilized was that normally practiced by the City of Beaumont. Results showed best results on the dosage curve to be:
1A. Utilizing CV 1730 at 40 ppm in concert with CV 6230P at 0.4 ppm, resulted in a final NTU of 0.15 in combination with 5 Standard Color Units.
1B Utilizing CV 1703 at 40 ppm without CV 6230P, resulted in a final NTU of 3.1 in combination with 14 Standard Color Units.
2A Utilizing CV 1120 and CV 3210 in a mass ratio of 20:1 at 60 ppm with 0.4 ppm of CV 6230 P, resulted in a filtered NTU of 0.30 with 13 Standard Color Units.
2B Utilizing CV 1120 and CV 3210 in a mass ratio of 20:1 at 45 ppm without CV 6230 P, resulted in a filtered NTU with 12.1 with 9 Standard Color Units.
3A Utilizing CV 1120 and CV 3650 in a mass ratio of 20: 1 at 60 ppm with 0.4 ppm of CV 6230 P, resulted in a filtered NTU of 0.05 with 7 Standard Color Units.
3B Utilizing CV 1120 and CV 3650 in a mass ratio of 20:1 at 45 ppm without CV 6230 P, resulted in a filtered NTU of 9.3 with 15 Standard Color Units.

### Example 22

Marshall, Tex.—Marshall's production is difficult with salt chemistry:
The raw alkalinity is less than 20 ppm and often as low as 6 ppm,
The raw turbidity is 2 to 11 NTU,
The raw color varies from 40 to 300 Standard Color Units, and
The raw TOC range from 6 to 20 ppm.

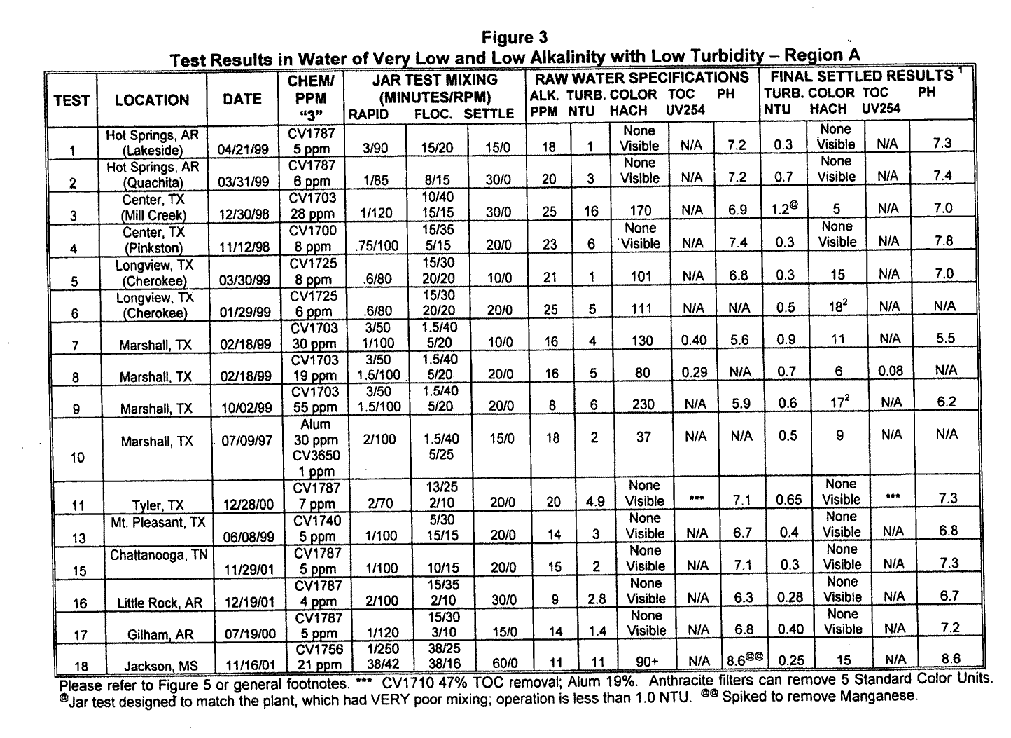

Since the City of Marshall was the first to utilize this chemistry on a production basis, the use of Cationic Polyacrylamide to replace high molecular weight DADMAC was jar tested. The results were very positive. Two sets of jar tests were performed. The jar test sequence is that normally utilized by the City of Marshall. The first set was performed with the current CV 1703 formulation referenced in FIG. 3. The second set was performed utilizing the same volume ratios in CV 1703 of AlxOHyClz, AlCl₃ and low molecular weight Epi-DMA, however, the 10 percent by volume high molecular weight DADMAC was replaced with 5 percent by volume CV 5180. The remaining 5% of the 1903 formulation was water. CV 5180 is an 80% cationic polyacrylamide having a molecular weight near 8 million. This blend utilizing the CV 5180 is labeled CV 1903.

The raw water quality on Apr. 5, 2000 was 9.2 NTU with 160 Color Units. The best results of the two jar tests performance curves are:
A dosage of 35 ppm of CV 1703 resulting in a settled NTU of 0.98 and 13 Standard Color Units.
A dosage of 35 ppm of CV 1903 resulting in a settled NTU of 0.72 and 13 Standard Color Units.

### Example 23

The City of Port Arthur, Tex. operates a Pulsator Clarifier. Raw water quality varies from approximately 5 ppm to approximately 40 ppm of alkalinity, from approximately 10 to 100 NTU and from approximately 20 to 150 Standard Color Units. Jar tests were performed with CV 1756 resulting in less than 1.0 NTU and less than 5 Standard Color Units on many occasions during 1998 and 1999. CV 1756 is on a volume basis 65 to 68% of CV 1120, 25 to 30% CV 3210 and 7.5 to 10% CV 3250. CV 3250 is a 50% active high molecular weight Epi-DMA.

In November of 1999, Port Arthur was operating the Pulsator on alum with a low molecular weight DADMAC. Tests had been performed with alum and a medium molecular weight DADMAC achieving mixed results. At this time, plant performance with alum and DADMAC was not optimal; often the final NTU was in excess of 0.5. Upon plant start-up in November of 1999, the CV 1756 alone allowed floc to carry over the weirs. Jar tests were performed replacing the high molecular weight Epi-DMA in the CV 1756 formulation with high molecular weight DADMAC. The results were not as good as the Epi-DMA. Therefore, jar tests were performed using CV 5140 (cationic) and CV 6200 P (non-ionic) and CV 6230 P (anionic) polyacrylamide. Where good results were obtained with CV 5140 and CV 6230 P, the best results were obtained with CV 6200 P. Cytec 1986 (non-ionic polyacrylamide) was on site and performed nearly equivalent to CV 6200 P; therefore, Cytec 1986 was put into production with CV 1756.

Plant operation with CV 1756 and Cytec 1986 produced equivalent results to those of the jar tests. The raw water quality was approximately 25 to approximately 35 NTU with 25 to 40 Standard Color Units. CV 1756 operated at 15 to 18 mg/L and Cytec 1986 operated at a dosage of 0.2 to 0.45 mg/L. Weir NTU dropped from 3 to 5 NTU to less than 1.5 NTU and often to less than 1.0 NTU; the filtered NTU dropped to less than 0.15 NTU. Later in the plant evaluation, high winds caused waves in the clarifier; these winds were the reason for the Cytec 1986 increases to 0.45 mg/L.

### Example 24

The City of Shreveport, La. produces water with a traditional settling basin clarifier. Raw water alkalinity varies from approximately 10 ppm to approximately 40 ppm, turbidity varies from approximately 10 to approximately 45 NTU and color varies from approximately 30 to over 150 Standard Color Units.

CV 1795 was jar test evaluated to be the optimum combination for this water. The jar testing sequence utilized is that utilized by the City of Shreveport. CV 1795 is by volume 45% CV 1120, 15% CV 3250 (high molecular weight Epi-DMA being 8,000 cps at 50% active), 30% CV 3210 and 10% water. CV 1795 was then compared to CV 1995. CV 1995 has the same ratios as CV 1795, except the CV 3250 is replaced with 5% of CV 5180 (80% cationic polyacrylamide which is a 40% active emulsion). The remaining 10 percent of the CV 1995 formulation is water. The results of CV 1795 and CV 1995 were very comparable.

On Apr. 6, 2000, the raw water quality in Shreveport was 13.1 NTU and 146 Color Units. Jar testing with CV 1795 produced 0.47 NTU and 8 Color Units at 9 ppm. Jar testing with CV 1995 produced 0.53 NTU and 8 Color Units at 9 ppm.

### Example 25

Marshall, Tex.—Marshall's raw water makes production difficult with salt chemistry.
The raw alkalinity is less than 20 ppm and often as low as 6 ppm,
The raw turbidity is 2 to 11 NTU,
The raw color varies from 40 to 300 Standard Color Units, and
The raw TOC ranges from 6 to 20 ppm.

Since the City of Marshall was the first to utilize this chemistry on a production basis, the importance of the molecular weight of the DADMAC is tested in Marshall. Three sets of jar tests were performed. The jar test sequence is that normally utilized by the City of Marshall. The first set was performed with the current CV 1703 formulation referenced in FIG. 3. The second set was performed utilizing the same volume ratios in CV 1703 replacing the high molecular weight DADMAC (CV 3650) measuring 2,000 cps at 20% active with a low molecular weight DADMAC measuring 200 cps at 20% active. The third set was performed replacing CV 3650 with a medium molecular weight DADMAC measuring 780 CPS at 20% active.

The raw water quality on 5/14/99 was 12 NTU with 184 Color Units. The best results of the three jar test performance curves are:
A dosage of 28 ppm of CV 1703 “HMW DADMAC” resulting in a settled NTU of 0.72 and 8 Standard Color Units.
A dosage of 32 ppm of CV 1703 “LMW DADMAC” resulting in a settled NTU of 2.31 and 34 Standard Color Units.
A dosage of 30 ppm of CV 1703 “MMW DADMAC” resulting in a settled NTU of 1.1 and 18 Standard Color Units.

The test results suggest that in waters where a HMW AmP performs very well, a MMW AmP may perform substantially equivalently, or at least well enough to meet targeted standards.

### Example 26

In Marshall, Tex., CV 1703 has been documented to remove TOC down to the SOC level. To enhance SOC removal, many reformations of CV 1703 were evaluated producing no improvement in SOC removal. Further, in combination with CV 1703, KMnO₄ and KMnO₄ with Powdered Activated Carbon were evaluated; there was no improvement in DOC removal. Finally, alum was evaluated in combination with KMnO₄ and KMnO₄ with Powdered Activated Carbon; in this case, there was a slight improvement in DOC removal, however, not enough to allow Marshall to remove enough of the SOC.

Since alum had a slight improvement over that of CV 1703 in removing SOC, it was theorized to use the new sulfated versions of AlxOHyClz. This theory was based on the sulfate anion combining with DOC by nucleophillic substitution, thereby allowing coagulation. Where the sulfated versions of Al_{X}OH_{Y}Cl_{Z} in CV 1703 performed equivalently on a % Al₂O₃ basis as compared to CV 1120 in CV 1703, there was no improvement in SOC removal.

Further bench tests in Marshall with CV 1787 and CV 1703 reveal maximal Aluminum concentrations in the clarified water of 0.15 mg/L with most results non-detect by a Hach DR 2000. Actual production results measured by the TNRCC reveal a maximum aluminum concentration in the final water of 0.05 mg/L, with most results non-detect.

### Example 27

The City of Hot Springs, Ark. produces water from Lake Quachita. The raw water quality is low alkalinity with low turbidity (having no calcium in the raw water). Lake Quachita does not measure any appreciable color in the water. Raw water alkalinity varies from about 10 to 30 ppm; NTU varies from about 10 to 30 ppm.

CV 1787 was tested in Hot Springs at the Quachita Facility. CV 1787 is by volume 85% CV 1120 (50% active, 84% basic Al_{X}OH_{Y}Cl_{Z}) and 15% CV 3250 (HMW Epi-DMA measuring 9,000 cps at 50% active). CV 1787 was compared to a version replacing CV 3250 with CV 3210 which is a low molecular weight Epi-DMA measuring 120 cps at 50% active. A third test was performed replacing CV 3250 in the CV 1787 formulation with a medium molecular weight Epi-DMA, CV 3230. CV 3230 measures approximately 3,500 cps at 50% active.

On Mar. 31, 1999 the raw water quality was 20 ppm of alkalinity and 2.5 NTU. The best results of the dosage curves were:
A dosage of 6 ppm of CV 1787 “HMW Epi-DMA: resulting in a settled NTU of 0.7.
A dosage of 5 ppm of CV 1787 “LMW Epi-DMA: resulting in a settled NTU of 1.9.
A dosage of 6 ppm of CV 1787 “MMW Epi-DMA: resulting in a settled NTU of 1.1.

The example suggests that in waters where a HMW AmP performs very well, a MMW AmP may perform substantially equivalently, or at least well enough to meet targeted standards.

Operation with alum is normally 30 ppm placing over 0.5 ppm of aluminum in the drinking water. CV 1787 places no aluminum in the drinking water.

### Example 28

The City of Arlington, Tex. produces municipal water from two plants, the Pierce Burch (PB) and the John Kabala (JK) plants. Arlington has installed ozonation facilities at each. The coagulation chemicals at each are currently alum in concert with a low molecular weight DADMAC. Where the pre-ozonation provides micro-flocculation to enhance the effectiveness of the alum, the resulting floc is rather small. The filter loadings at both facilities are so significant that filter run times are often less than 20 hours.

At the PB Plant, CV 1754 and CV 1788 were found to produce water at less than 1.0 settled NTU at dosages of less than 8 mg/L while the plant was operating at 0.8 mg/L of ozone pre-treatment with 25 mg/L of alum and 1.1 mg/L of low molecular weight 40% active DADMAC. CV 1754 is by volume 70% CV 1120 (50% active, 84% basicity ACH), 10% CV 3650 (high molecular weight DADMAC being 2,000 cps at 20% active) and 20% CV 3250 (high molecular weight Epi-DMA being 8,000 cps at 50% active). CV 1788 is by volume 80% CV 1120, 10% CV 3650 and 10% CV 3210 (low molecular weight Epi-DMA being 100 cps at 50% active).

At the PB Plant, where CV 1788 performed very well in the non-ozonated water, the performance was not acceptable in the pre-ozonated water. In contrast, the CV 1754 performed very well in the water with 0.8 mg/L of pre-ozonation; in that water CV 1754 produced a settled NTU of 0.95 at 8 mg/L. During this period, filter hours were less than 20. On this day an additional test was performed with a compound that included cationic polyacrylamide. This tested combination, CV 1901 is by volume 90% CV 1120, 6% CV 5160 (a 60% cationic polyacrylamide being 40% active in a mineral oil emulsion) and 4% water. CV 1901 produced a settled NTU of 0.91 at 8.0 mg/L in 0.8 mg/L pre-ozonated water and produced a settled NTU of 0.88 at 6.5 mg/L in non-ozonated.

At the JK plant, tests with water pre-ozonated showed CV 1780 to perform at 0.6 settled NTU at 3 mg/L; JK normally operates with 10 mg/L of Alum in concert with 1.0 mg/L of a 40% active low molecular weight DADMAC producing a settled NTU of approximately 1.0 NTU. CV 1780 is by volume 50% CV 1120 and 50% CV 3650. These tests showed the ozonated water to be very sensitive to the amount of CV 3650; a 40/60 ratio could not obtain less than 1.0 NTU.

Follow-up jar testing at both facilities found CV 1120 in combination with CV 3650 to be optimal at both facilities (CV 1780 is a 50/50 blend of CV 1120 with CV 3650), reducing the dosage, chemical cost, operating cost and the final filtered NTU to less than that of alum.

### Example 29

The City of Springfield, Mo. produces municipal water from three water production plants. Where raw water turbidity spikes can run as high as 50 NTU, the normal raw NTU is less than 5 with the raw alkalinity normally over 100 mg/L; there is no measurable color.

The current chemical treatment program is with General 4090, a 50% active 70% basic aluminum hydroxychloride. The current dosage is near 8 mg/L with the settled NTU near 0.3 NTU. Jar testing with CV 1745 (70% by volume CV 1120 (50% active 84% basic aluminum chlorohydrate), 20% by volume CV 3650 (20% active DADMAC being 2,000 cps) and 10% by volume CV 3210 (50% active Epi-DMA being 100 cps) or CV 3620 (40% active DADMAC being 100 cps). CV 1785 (90% CV 1120, 2.5% CV 3250 and 7.5% CV 3210 and CV 1788 (80% CV 1120, 10% CV 3650 and 10% CV 3210) produced settled NTU's of less than 0.5 NTU at dosages of less than 4 mg/L.

### Example 30

The City of Kansas City, Mo. operates a 210 MGD lime softening facility normally producing water with less than 0.1 NTU and less than 80 mg/L of hardness.

During the winter months cold temperatures do not allow the lime to flocculate properly producing settled water in the final basins from 10 to over 20 NTU. In addition, the spring rains cause the same challenge with respect to final turbidity performance producing a final settled NTU of 5 to over 20.

Jar tests were performed utilizing CV 1788 which is by volume 80% CV 1120 (50% active aluminum chlorohydrate that is 84% basic), 10% CV 3210 (50% active Epi-DMA measuring 100 cps) and 10% CV 3650 (20% active DADMAC measuring 2,000 cps). At dosages of 1 to 3 m/L, settled NTU's of less than 1.0 were achieved.

### Example 31

The City of DeQueen, Ark. has low alkalinity/low to moderate turbidity raw water that has a minimum of 4 mg/L of mineral salts. Due to the concentration of mineral salts in the water, it has been found that the medium, high, and very high AmP's are not required for water clarification. It is believed that the mineral content of this raw water causes this raw water to perform uniquely. Further, AP's and AS's in concert with low molecular weight quaternary ammonium compounds perform very poorly.

However, where the combination of an AP alone will perform satisfactorily, an AP with an AS or an AP with an AS and with a low molecular weight quaternary ammonium polymer perform excellently. NTU results for this testing is:

| Product | Dosage | Settled NTU |
|---|---|---|
| CV 1787 | 13 | >3.0 |
| CV 1120 | 13 | 0.93 |
| CV 1170 | 13 | 0.25 |
| CV 1180 | 13 | 0.34 |
| CV 1190 | 13 | 1.1 |

### Example 32

During the summer of 2000, two bulk storage tanks formed an agglomeration of aluminum hydroxide intermixed with AmP. The product in both cases was CV 1703. Upon investigation, the cause of this precipitate agglomeration was evaporation of water from the blended AP/AmP solution. This was determined by residual sodium analysis. The mg/L of sodium in both cases doubled from nearly 400 mg/L to nearly 800 mg/L; in addition, the CV 1703 thickened significantly before forming the precipitated agglomeration.

Further investigation found other aluminum compounds to have the same challenge. Beakers of alum, aluminum chloride and aluminum chlorohydrate were left open in direct sunlight. All formed aluminum hydroxide precipitates when the solubility point was crossed due to water evaporation.

As a result of this work, all customers of this technology are recommended to install nitrogen blanket/vent systems to insure that the product does not form a precipitate, thereby remaining stable.

### Example 33

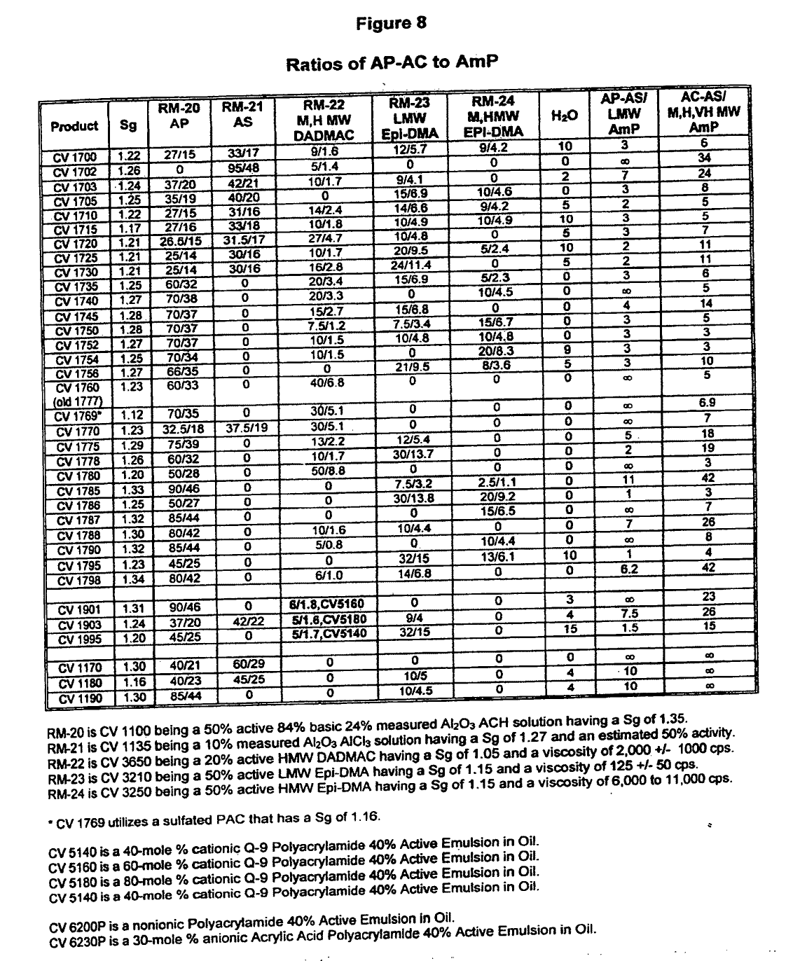

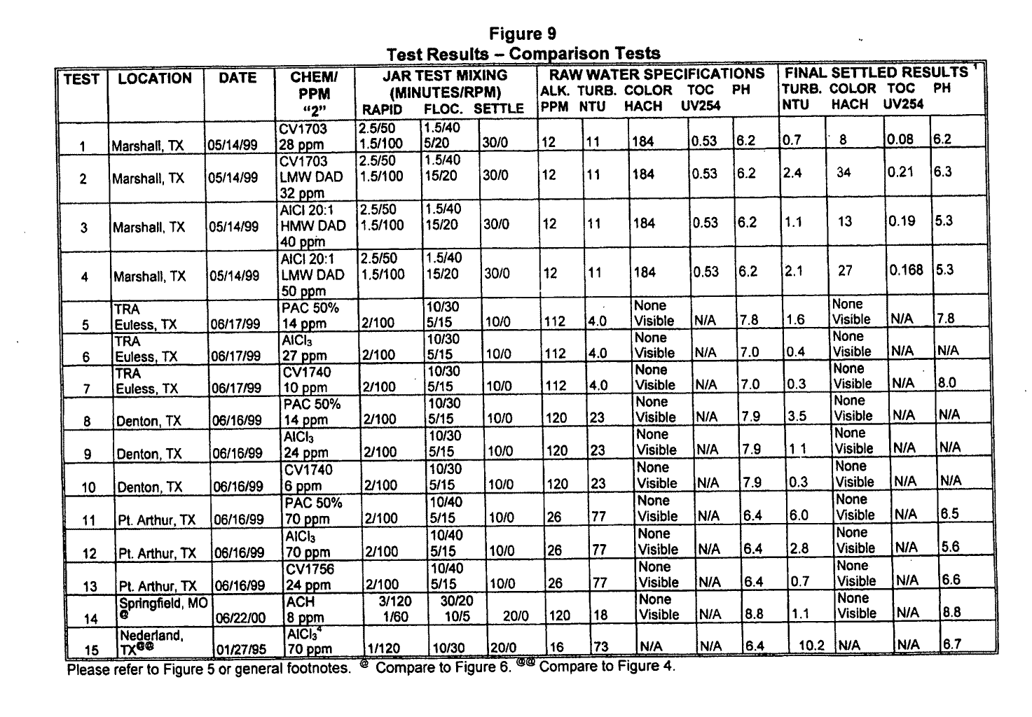

The raw waters of the Northwestern United States tend to be very low in alkalinity, low in turbidity and very low in TOC. Jar testing performed in the Portland, Oreg. area further defines the importance of molecular weight in the applicability of AP's:
1. McMinnville, Oreg. operates a 6 MGD drinking water facility that has a traditional settling basin. An in-line venturi operates as the rapid mix and a 3 foot wide channel perform flocculation. The jar test sequence is approximately 45 seconds at 150 rpm, 10 minutes at 20 rpm and 20 minutes settling. The raw alkalinity is approximately 12 ppm, the raw NTU is normally approximately 1, yet can increase to 20 during rain events; there is no raw color or significant TOC. Operation with alum normally obtains a settled NTU greater than the raw (over 1 NTU with an optimum of dosage 10 to 15 ppm of alum). Jar testing with the CV 1700 Series products in FIG. 8 found none of the polymers to contain enough molecular weight for a floc to form with ACH. A final series of tests were performed with CV 1120 (84% basic, 24% Al₂O₃ ACH) with CV 6200P (non-ionic PA 40% in emulsion with a molecular weight of about 12 million by intrinsic viscosity). Two ppm of CV 1120 in combination with 0.5 ppm of CV 6200P obtained a settled NTU of 0.65.
2. Estacada, Oreg. operates a 2 MGD drinking water facility that has a traditional settling basin. The facility has a good rapid-mix and flocculation system. The jar test sequence is approximately 90 seconds at 120 rpm, 15 minutes at 20 rpm, 5 minutes at 10 rpm and 20 minutes settling. The raw alkalinity is near 12 ppm, the raw NTU is normally approximately 1, yet can increase to 10 during rain events; there is no raw color or significant TOC. Operation with alum normally obtains a settled NTU greater than the raw water (optimum dosage is 15 to 20 ppm of alum). Jar testing with the CV 1700 Series products in FIG. 8 found CV 1791 to perform best; however, the floc was too small leaving the fmal settled NTU over 1. A fmal series of tests were performed with CV 1791 in combination with CV 5160P (Q9 60 mole % cat-ionic PA 40% in emulsion with a molecular weight of about 7 million by intrinsic viscosity). Two ppm of CV 1791 in combination with 0.3 ppm of CV 5160P obtained a settled NTU of 0.55.

### Example 34

Mena, Ark. operates a 3 MGD drinking water facility that has a solids contact clarifier. The facility has a good rapid-mix and flocculation system. The jar test sequence is approximately 90 seconds at 120 rpm, 1 minute at 80 rpm, 15 minutes at 20 rpm, 5 minutes at 10 rpm and 20 minutes settling. The raw alkalinity is near 4, the raw NTU is normally approximately 1 to 8; there is no raw color or significant TOC. Operation with alum normally obtains a settled NTU of near 0.9 requiring caustic to grow a hydroxide floc (Optimum dosage is near 60 ppm of alum; Mena has measured aluminum in the final purified water over 0.5 mg/L on operation with alum.). Jar testing with the CV 1700 Series products in FIG. 8 found the H MW DADMAC blends to start a floc, yet the floc would fall apart before the end of flocculation. (Example 13 was found difficult to repeat.) A final series of tests were performed with CV 1777 in combination with CV 5120P (Q9 20 mole % cat-ionic PA 40% in emulsion with a molecular weight of about 10 million by intrinsic viscosity). Having a raw NTU of 7.5 ppm of CV 1777 in combination with 0.5 ppm of CV 5120P obtained a settled NTU of 0.65.

### Example 35

Nashville, Ark. operates a dissolved air flotation system (DAF) at the waste water treatment plant. The DAF removes TSS (primarily algae) from the water prior to discharge. Beginning in 2000, Nashville replaced the alum/anionic polyacrylamide combination on the DAF with a 60% cationic Q9 dry polyacrylamide having a molecular weight of approximately 8 million, as measured by intrinsic viscosity. DAF performance is well within the 10 TSS operating specification with only approximately 3 ppm of polymer. On Jan. 10, 2003 a H MW DADMAC, specifically CV 3650 (20% active 2000 cps) was evaluated on the DAF at dosages of up to 20 ppm. Under no circumstance could the H MW DADMAC outperform the cationic PA.

### Example 36

Bosier City, La. operates a 20 MGD drinking water facility that has solids contact clarifiers. The facility has a good rapid-mix and flocculation system. The jar test sequence is approximately 1 minute at 120 rpm, 20 minutes at 50 rpm, 5 minutes at 10 rpm and 20 minutes to settle. The raw alkalinity is near 100, the raw NTU is normally approximately 15 to 30; there is normally about 60 apparent color units. Due to performance issues, Bosier City left AS and IS operation in the 1990's, preferring operating with an ACH/LMW Epi-DMA blend. However, required operation at less than 0.10 filtered NTU has Bosier City incapable to maintain filtered NTU at less than 0.10 without the addition of a filter aid (H MW DADMAC). In February 2003, the Bosier City drinking water plant operated for 10 days on CV 1735 at dosages of 9 to 11 ppm, having NTU's of: raw near 20, settled near 1.0 and filtered near 0.07 to 0.08. During that time, jar tests performed indicate that CV 1752 can outperform CV 1735. A plant evaluation for CV 1752 is planned in May of 2003. Continuous operation below 0.10 filtered NTU without a filter aid has proven impossible with an AS, an IS or any L MW AmP/ACH blend evaluated.

### Example 37

Rancho Viejo, Tex. operates a 0.5 MGD drinking water facility that has a solids contact clarifier. The facility has a good rapid-mix and flocculation system. The jar test sequence is approximately 3 minutes at 120 rpm, 1 minute at 80 rpm, 20 minutes at 20 rpm, 5 minutes at 10 rpm and 20 minutes to settle. The raw alkalinity is near 100, the raw NTU is normally approximately 15 to 40; there is normally about 60 apparent color units. Due to performance issues, Rancho Viejo left alum operation in 2001. Rancho Viejo has operated on CV 1788 during 2002 at dosages of 25 to 40 mg/L, depending on raw NTU. During that year of operation Rancho Viejo has maintained all required state NTU, TOC and color requirements. Previous operation with alum and previous attempts with L MW AmP/ACH blend proved unreliable.

### Example 38

Brownsville, Tex. operates two drinking water plants. Both systems are traditional settling basins; the city produces an average of 30 MGD. Per tabulations in FIGS. 6 and 7, the optimum product for Plant 1, as identified in numerous jar tests is CV1788, and the optimum product for plant 2 is CV 1752. In Brownsville, the raw alkalinity is near 110 ppm, the raw NTU varies from 10 to 30, the TOC is normally near 5 ppm and the color is normally near 60 Units at Plant 2.

A plant evaluation of CV 1788 was performed on plant 2 during the months of March/April 2003. From a historical perspective, in 2002 a L MW AmP/ACH blend of another supplier was attempted at the same facility; the product performed so poorly that the evaluation was discontinued in 1 day of operation.

Operation with CV 1788 maintained filtered turbidity at less than 0.10. Further, measurable aluminum was noticeably absent from the drinking water sampled. Most notably TOC removal increased from approximately 23% on average to near 35% on average. (Brownsville is required to obtain 25% removal.)

### Example 39

Detroit, Mich. operates four drinking water plants. All systems are traditional settling basins; the city produces an average of 800 MGD. Per the tabulation in FIG. 6, the optimum product as identified in a jar test is CV 1798. The raw alkalinity is near 90 ppm (having approximately no calcium), the raw NTU varies from 1 to 10 (normally near 1.5), the TOC is normally near 1 ppm and there is no color.

Numerous jar tests at the NE Plant have demonstrated CV 1798 as the optimal product. At 3 to 5 ppm, CV 1798 outperforms alum obtaining near 0.5 settled NTU, wherein the alum dosage is normally 20 to 30 mg/L, depending on raw turbidity, obtaining near 1.0 settled NTU.

Further, the alum reduces the pH to near 7, causing significant corrosion challenges in distribution; CV 1798 maintained the raw pH. Alum places 0.2 to 0.5 ppm of aluminum in the drinking water. CV 1788 places no aluminum in the water.

### Example 40

Little Rock, Ark. operates two drinking water plants. Both systems are traditional settling basins; the city produces an average of 60 MGD. Per the tabulation in FIG. 3, the optimum product as identified in numerous a jar tests is CV 1787. The raw alkalinity is near 12 ppm (having approximately no calcium); the raw NTU varies from 1 to 3 (normally near 1.5); the TOC is normally near 2 ppm and there is no color.

Numerous jar tests have demonstrated CV 1787 as the optimal product. At 2 to 4 ppm, CV 1787 obtains near 0.3 settled NTU, wherein the alum dosage is normally 12 to 15 mg/L obtaining near 0.7 settled NTU.

Further, alum places 0.3 to 0.5 ppm of aluminum in the drinking water. CV 1787 places no measurable aluminum in the water.

### Example 41

Ft. Worth, Tex. operates four drinking water plants. All systems are traditional settling basins; the city produces an average of 600 MGD. Per tabulations in FIGS. 6 and 7, the optimal product for the Rolling Hills Plant, as identified in numerous jar tests was determined to be CV 1735. In Ft. Worth, the raw alkalinity is near 110 ppm, the raw NTU varies from 10 to 30, the TOC is normally near 4 ppm and the color is normally near 60 Units.

A plant evaluation of CV 1735 was performed at the Rolling Hills Facility during the month of September 1999. From a historical perspective, this facility has historically operated with an IS and a Polydyne L MW DADMAC.

Operation with CV 1735:
1. Reduced filtered turbidity from near 0.25 to near 0.10,
2. Exceeded all color requirements,
3. Exceeded all TOC requirements,
4. Eliminated IS and DADMAC addition,
5. Eliminated lime addition,
6. Reduced coagulant feed to 100 lb. per million gallons, and
7. Reduced sludge volume by near 60 percent.

Further Test Results

FIGS. 3-8 show further testing results of various processes of the present invention in raw water of various alkalinities and turbidities. As used in these Figures, the stated TOC values are proportional to the UV-254 measurements. Unless otherwise specified, any measurements of TOC provided are the actual UV-254 measurements in units of m⁻¹.

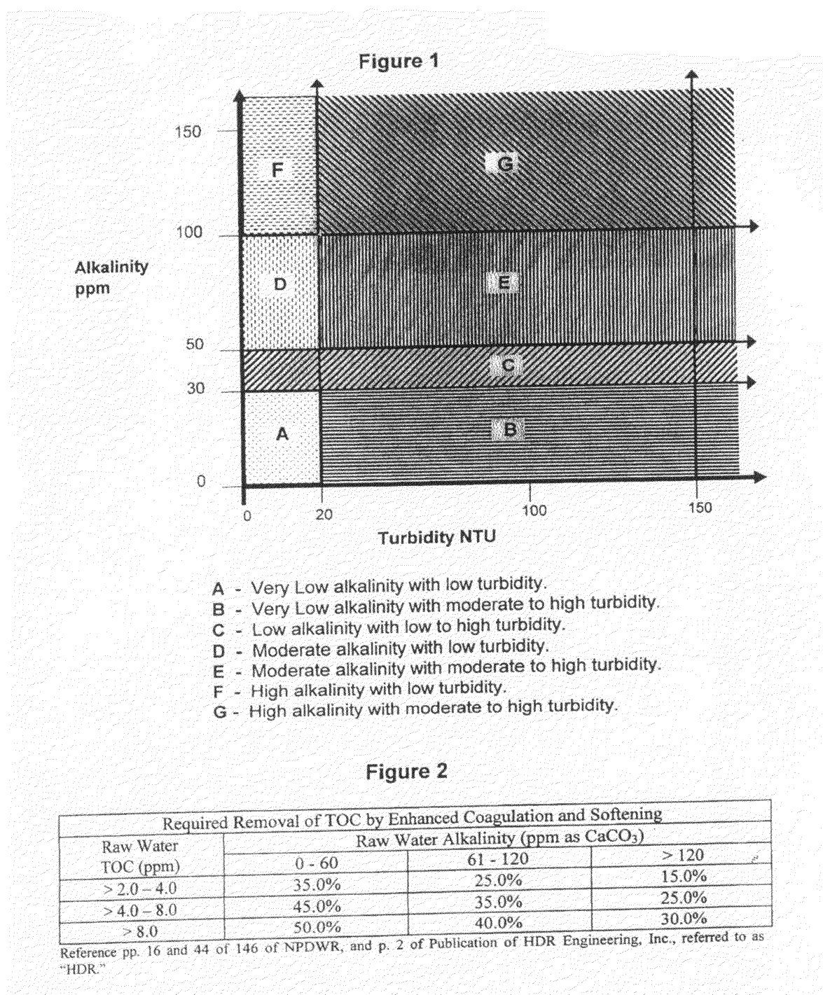

FIG. 3 refers to test results obtained for the region “A” shown in FIG. 1 in raw waters of very low alkalinity and low turbidity. As is demonstrated in FIG. 3, the alkalinities of the raw water ranged from between 8 ppm to 25 ppm and the turbidity ranged from between 1 NTU and 16 NTU. The resulting settled water turbidities ranged between 0.2 NTU and 0.9 NTU which are lower than the maximum turbidity requirements established by the government. The only case where the required turbidity for the settled water was not achieved was in test 3. Settled water turbidity of 1.2 NTU was achieved due to the fact that the jar tests were designed to match the plant capabilities. The plant in Center, Tex. had very poor mixing facilities. With plant modification, the operation of the plant provides settled water turbidity results of less than 1.0 NTU. Also, the color content of the raw water ranged between 37 and 260 Standard Color Units. The settled water had a color content ranging from 0 to 18 Standard Color Units. Only in two cases, the settled water color content was over the 15 Standard Color Units requirement. In test 6 and 9, the color content of the settled water was 18 and 17 Standard Color Units, respectively. However, it is well known in the art that anthracite filters can easily remove 5 Standard Color Units. Therefore, by using anthracite filters in those two cases, the achieved color content of the settled water shall be below 15 Standard Color Units, as required. Also, as shown on page 9, the required removal of TOC by enhanced coagulation and softening has to be at least 35.0% in a raw water of an alkalinity of at most 60 ppm and TOC of greater than 2.0 and up to 4.0 ppm. As demonstrated in FIG. 3, only in tests 7 and 8 the TOC was measured at UV-254 measurement of 0.40 and 0.29 m⁻¹, respectively. Upon treatment of the raw water, the settled water had no TOC after performance of the inventor's test. In test 8, the TOC as measured by UV-254 of the raw water was reduced from 0.29 to 0.08 m⁻¹, which is a reduction of approximately 70%, thus satisfying the required removal of TOC established. In test 11, upon using CV 1710, a 47% TOC removal was obtained, while by using alum alone, TOC removal of only 19% was achieved. Of course, it should be noted that all results obtained in the tables refer to the best results on curves that were obtained after treating the raw waters, as is commonly practiced in the industry.

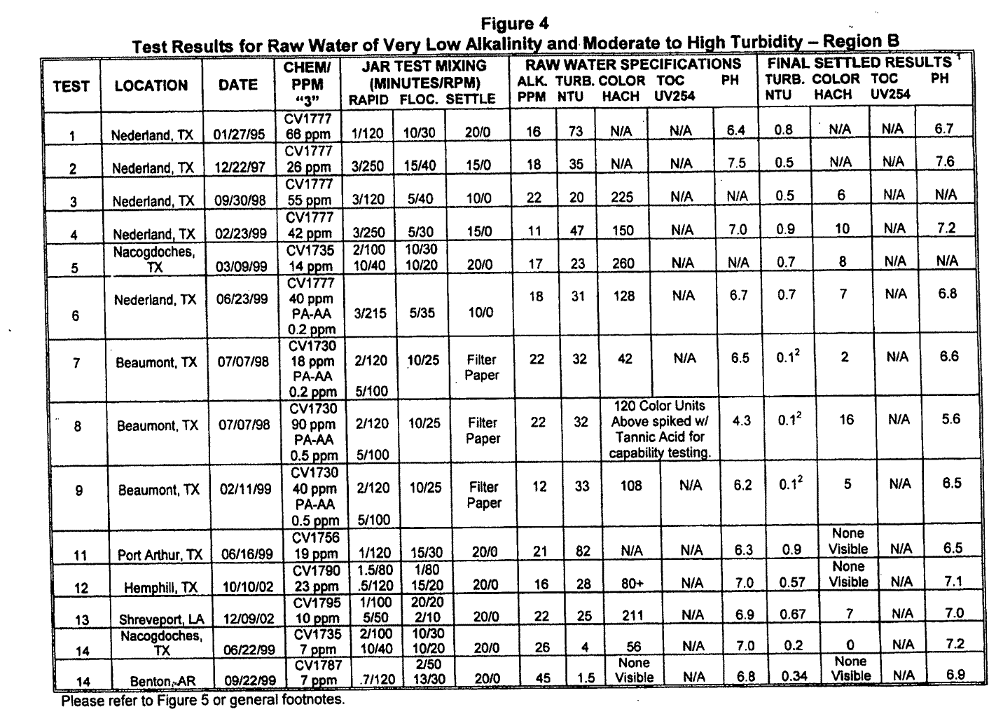

FIG. 4 refers to test results obtained for the region “B” shown in FIG. 1 in raw waters of low alkalinity and moderate to high turbidity. Again, FIG. 4 reflects that all the results that were obtained upon applying the claimed combinations were capable of achieving the required government standards of turbidity, color content and TOC removal. Regarding color, all tests that measured color content of the raw water and the settled water provided extraordinary results. In test 3, the raw water had a color content of 225 Standard Color Units, yet the settled water had a color content of 6 Standard Color Units which satisfies the maximum of 15 Standard Color Units. Similarly in tests 4, 5, 6 and 9, color content of the raw water (150, 260, 128 and 108 Standard Color Units) was reduced to under 15 Standard Color Units (i.e., 10, 8, 7 and 5 Standard Color Units). Only in test 9 was the color content of the settled waste over 15 (i.e., 16) Standard Color Units. However, in this case the raw water was spiked with tannic acid for capability testing, and in addition the color content can always be removed up to 5 Standard Color Units upon using anthracite filters (as specified for FIG. 3). In FIG. 4, TOC measurements were not considered.

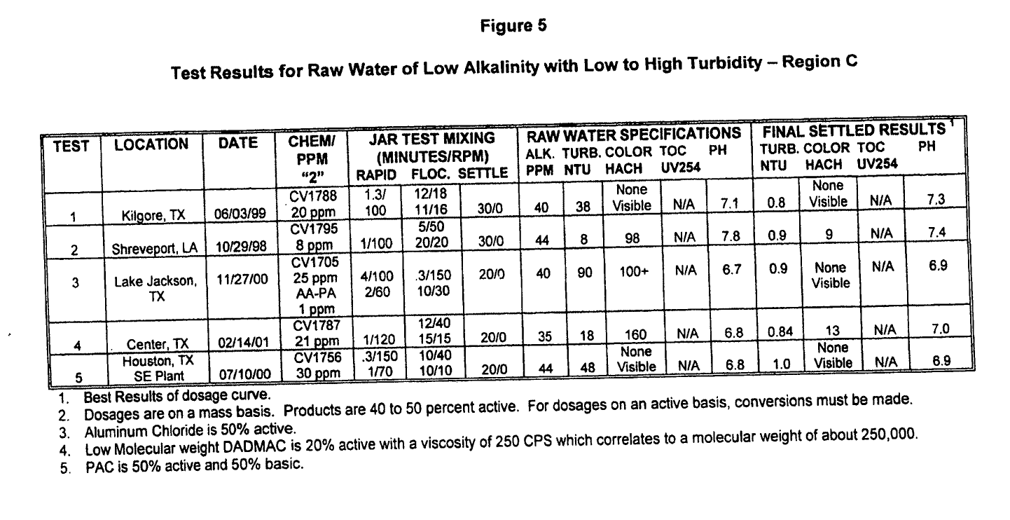

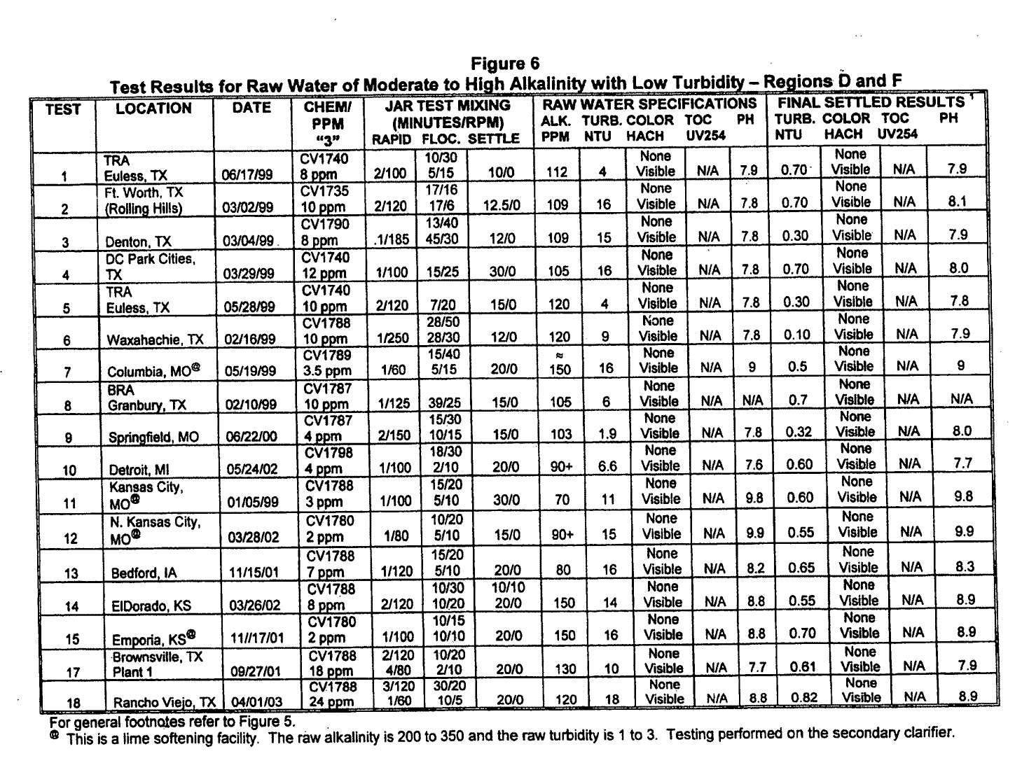

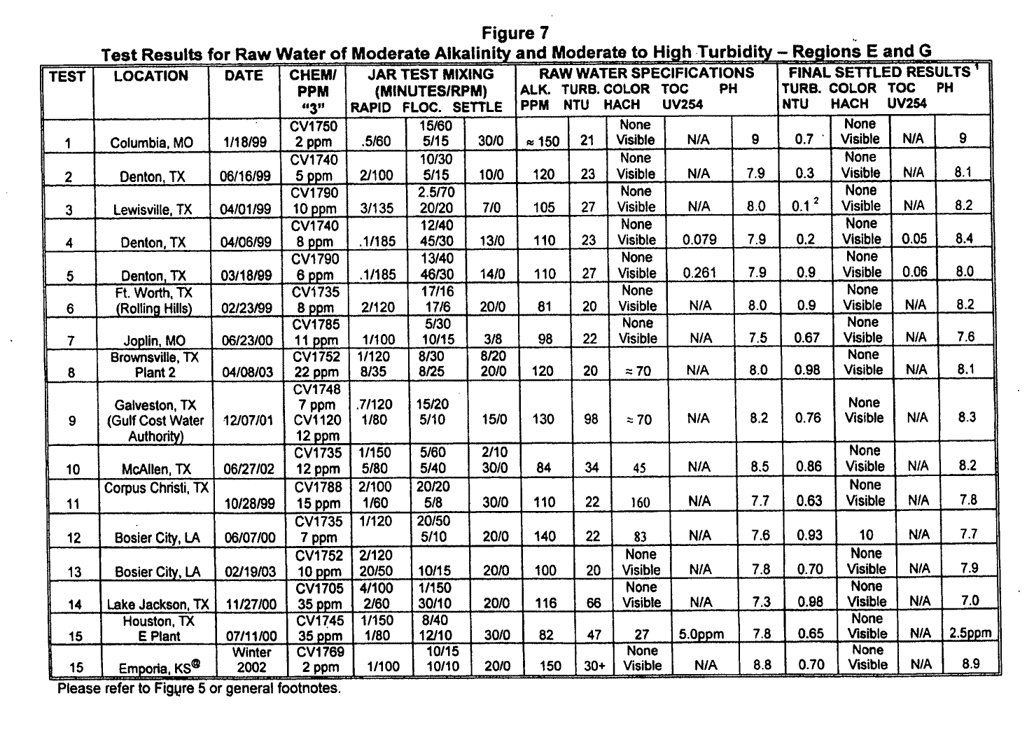

FIG. 5 refers to test results that were obtained for the region “C” shown in FIG. 1 in raw waters of moderate alkalinity and low, medium or high turbidity. The tests of FIG. 5 were run in raw waters having a raw turbidity from 8 to 90 NTU and an alkalinity of 35 to 44 ppm. The resulting turbidity of the settled water ranged from 0.8 to 1.0 NTU. The color content in test 2 was reduced from 98 Standard Color Units in the raw water to 9 Standard Color Units and in test 4 from 160 Apparent Color Units in the raw water to 13 Apparent Color Units in the settled water, satisfying present government standards. There was no measurement of the TOC removal in FIG. 5.

FIG. 6 refers to test results that were obtained for the regions “D” and “F” shown in FIG. 1 in raw waters of moderate and high alkalinity and low turbidity. In all the tests listed in FIG. 6, the turbidity of the settled was below 1.0 NTU, ranging between 0.10 to 0.82 NTU. It should be noted that the raw water turbidity ranged from 4 to 18 NTU. As is clearly indicated in FIG. 6, the raw water alkalinities of the test ranged between 70 and 150 ppm, qualifying the water as raw water with moderate and high alkalinity. The color content of the raw water was not visible and therefore was not tested. Although a portion of Section “D” of FIG. 1 (i.e., alkalinity ranging from 50 to 150 ppm) and low turbidities were demonstrated in Hassick, none of the results provided by Hassick achieved turbidity of under 1.0 NTU which is required by the present government standards. There is no upper limit on the high alkalinity range of Section E. It should also be noted that Section “G” does not have any upper limits on its turbidity range (as demonstrated by the continuous arrow on the right side of the graph). Similarly, Section D does not have a limitation of high turbidity and at the present, the same chemical compounds have worked in numerous raw waters of various turbidities.

FIG. 7 refers to test results that were obtained for the regions “E” and “G” shown in FIG. 1 in raw waters of moderate and high alkalinity and moderate to high turbidity. The turbidity of the raw water ranged between 20 and 98 NTU; while, the turbidity of the settled water ranged between 0.10 NTU and 0.98 NTU. Since there was no detectable color content, no results are listed in reference to the color content of the raw water or the settled water. TOC results within government specification are listed in tests 4, 5 and 15.

In FIGS. 9, 10 and 11 numerous other features that are important in the present application are shown. The molecular weight of the AmP does make a difference in the results. Comparison of test 1 with test 2 of FIG. 9 shows that when low molecular weight DADMAC was used, the resulting settled water turbidity was 2.4 NTU, while when high molecular weight DADMAC was used in the chemical compound, a turbidity of 0.7 NTU was obtained for the settled water upon using the exact same raw water.

Test 3 and test 4 of FIG. 9 can also be compared to show the effect of molecular weight of the AmP on the results. Using high molecular weight DADMAC and aluminum chloride alone provided a resulting turbidity of 1.1 NTU, while under the exact same conditions, using aluminum chloride with low molecular weight DADMAC provided a turbidity of 2.1 NTU for the settled water. In test 5-7 of FIG. 9, the use of poly-aluminum chloride alone provided a turbidity of 1.6 NTU for the settled water while the use of aluminum chloride alone provided a turbidity result of 0.4 NTU for the settled water. However, as stated before, higher dosages of aluminum compounds are not desired for treating settled water. Under the exact same conditions, a settled water turbidity of 0.3 NTU was obtained (refer to test 7). Similarly in tests 9 to 10, the results that were obtained by using the chemical compound resulted in a settled water turbidity of 0.3 NTU; while under the same conditions, poly-aluminum chlorohydrate and aluminum chloride each provided a turbidity of 3.5 NTU and 1.1 NTU, respectively. Tests 11 to 13 of FIG. 9 are very similar and indicate again that the compound performs even much better than the single components themselves do, achieving a settled water turbidity of 0.7 NTU versus achieving turbidities of 2.8 and 6.0 NTU in the settled water. It should also be noted that using low molecular weight quaternized ammonium polymers (versus medium, high and/or very high AmP) does not even provide satisfactory results regarding color content, with test 1 to 4 of FIG. 9 showing that color content of 8 and 13 Standard Color Units were obtained when high molecular weight AmP's are used while a color content of 34 and 27 Standard Color Units were obtained when low molecular weight quaternary ammonium polymers were used.

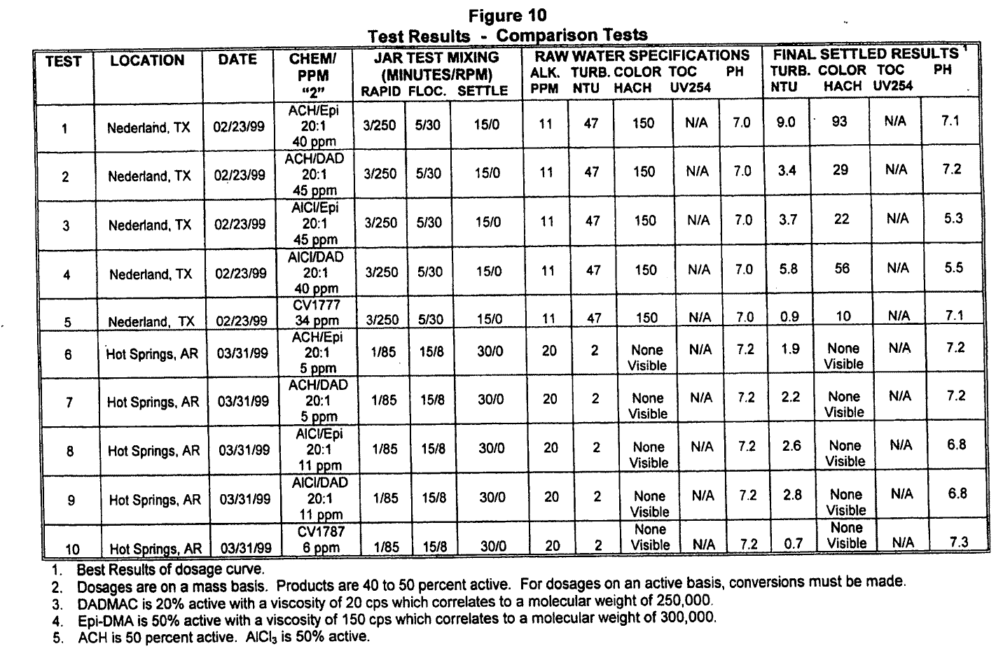

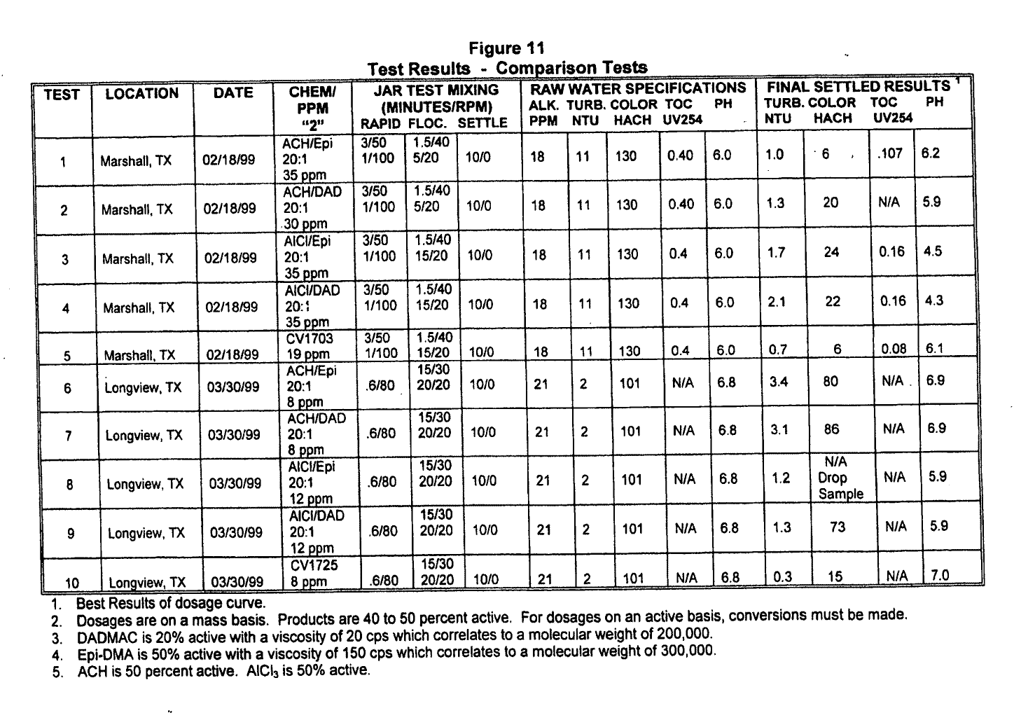

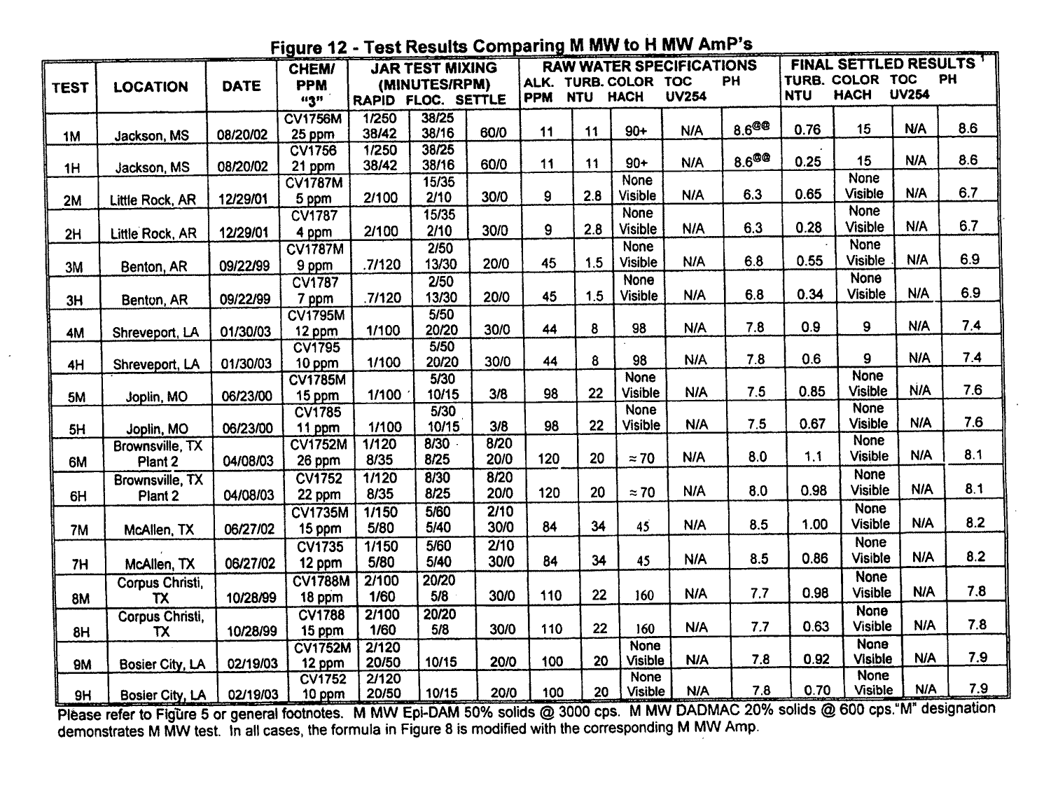

FIGS. 10 and 11 make direct comparisons to Hassick, using claimed ratios from Hassick '039 and '457. The results are not comparable and are not acceptable to today's government standards, as are depicted in FIG. 1 through 7. In summary, FIGS. 9, 10 and 11 demonstrate that molecular weight does make a difference. Further, the molecular weight of an AmP used in combination with either an AS or an AP can define the performance of the coagulation system. Give the results of Hassick, this very important aspect was missed by Hassick and by the industry.

FIG. 12 presents further comparisons of M MW AmP combined with AP in comparison to H MW AmP with AP.

The test results prove that the combinations claimed by the applicant are capable of achieving the required government standards of TOC removal, specifically the insoluble component (IOC), non-DOC component, in raw waters of:
(a) alkalinity of less than 30 ppm and turbidity of less than 20 NTU (as shown by Section A of FIG. 1);
(b) alkalinity of less than 30 ppm and turbidity of between 20 NTU and 150 NTU (as shown by Section B of FIG. 1);
(c) (c) alkalinity of between 30 ppm and 50 ppm and any turbidity (as shown by Section C of FIG. 1)
(d) alkalinity of greater than 50 ppm and turbidity of greater than 20 NTU (as shown in Section E and G of FIG. 1); and
(e) alkalinity of greater than 50 ppm and turbidity of less than 20 NTU (as shown by section D and F of FIG. 1).

It is also inherently obvious that the production of these high and very high molecular weight polymers is more costly than their low molecular weight counterparts due to equipment investment and equipment utilization. AmP's obtain their molecular weight in direct proportion to reactor residence time. Production of organic polymers with high and very high molecular weights requires significantly increased reaction times. Further, production of high and very high molecular weight solution polymers necessitates improvements in equipment due to viscosity increases that occur at molecular weights over 2,000,000. Only in the last 8 years have these equipment restrictions been overcome. Due to these production expenses, industry took many years to address the production technology issues. The high and very high molecular weight AmP's can now be combined with the AP's to create a novel generation of water treatment chemicals.

Certain objects are set forth above and made apparent from the foregoing description, tables, drawings and examples. However, since certain changes may be made in the above description, tables, drawings and examples without departing from the scope of the invention, it is intended that all matters contained in the foregoing description, tables, drawings and examples shall be interpreted as illustrative only of the principles of the invention and not in a limiting sense. With respect to the above description, tables, drawings and examples then, it is to be realized that any descriptions, tables, drawings and examples deemed readily apparent and obvious to one skilled in the art and all equivalent relationships to those stated in the tables, drawing and examples and described in the specification are intended to be encompassed by the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention. It is also to be understood that the following claims are intended to cover all of the generic and specific features of the invention herein described, and all statements of the scope of the invention which, as a matter of language, might be said to fall in between.

I claim:

1. A composition comprising:
an aluminum polymer with
an ammonium polymer or an acrylamide polymer, wherein
pH of the composition is below 6.

2. The composition of claim 1, wherein
said aluminum polymer comprises a basicity of greater than about 50 percent.

3. The composition of claim 1, wherein
said aluminum polymer comprises aluminum chlorohydrate.

4. The composition of claim 1, wherein
said aluminum polymer comprises at least one selected from the list consisting of: aluminum chlorohydrate, aluminum hydroxychloride, polyaluminum chloride, polyaluminum hydroxysulfate, polyaluminum hydroxy chlorosulfate, polyaluminum chlorosulfate calcium chloride, a polyaluminum hydroxy “metal” chloride and/or sulfate, or a polyaluminum “metal” chloride and/or sulfate, and the like, and any combination therein.

5. The composition of claim 1, wherein said ammonium polymer comprises a vinyl polymer.

6. The composition of claim 5, wherein said vinyl polymer is formed with sodium persulfate.

7. The composition of claim 1, wherein said ammonium polymer comprises DADMAC.

8. The composition of claim 7, wherein said DADMAC is formed with sodium persulfate.

9. The composition of claim 1, further comprising hydrobromic acid.

10. The composition of claim 1, further comprising hydrochloric acid.

11. The composition of claim 1, wherein said pH of said ammonium polymer or of said acrylamide polymer to less than 6 prior to blending with said aluminum polymer.

12. The composition of claim 1, wherein said pH is 4.25±0.25.

13. The composition of claim 1, wherein said ammonium polymer comprises a condensation polymer of epichlorhydrin and amine.

14. The composition of claim 13, wherein said ammonium polymer comprises Epi-DMA.

15. The composition of claim 13, wherein said ammonium polymer comprises an acid not comprising sulfur.

16. The composition of claim 15, wherein said acid comprises hydrochloric acid.

17. The composition of claim 1, wherein said acrylamide polymer comprises a cationic polyacrylamide.

18. The composition of claim 1, wherein said acrylamide polymer comprises non-ionic polyacrylamide.

19. The composition of claim 1, further comprising an aluminum salt, excluding alum.

20. The composition of claim 19, wherein the basicity is below 55 percent.

21. The composition of claim 19, wherein the basicity is below 45 percent.

22. The composition of claim 1, wherein said composition is formed with high shear mixing during combination of any aluminum containing chemical.

23. The composition of claim 1, wherein said composition is a coagulant.

24. The composition of claim 1, further comprising water.

25. A method of blending an aluminum polymer with at least one of an ammonium polymer and an acrylamide polymer, the method comprising
adjusting pH of the ammonium polymer and/or polyacrylamide to below 6 prior to blending with the aluminum polymer.

26. The method of claim 25, wherein
said aluminum polymer comprises a basicity of greater than about 50 percent.

27. The method of claim 25, wherein
said aluminum polymer comprises aluminum chlorohydrate.

28. The method of claim 25, wherein
said aluminum polymer comprises at least one selected from the list consisting of: aluminum chlorohydrate, aluminum hydroxychloride, polyaluminum chloride, polyaluminum hydroxysulfate, polyaluminum hydroxy chlorosulfate, polyaluminum chlorosulfate calcium chloride, a polyaluminum hydroxy “metal” chloride and/or sulfate, or a polyaluminum “metal” chloride and/or sulfate, and the like, and any combination therein.

29. The method of claim 25, wherein said ammonium polymer comprises a vinyl polymer.

30. The method of claim 29, wherein said vinyl polymer is formed with sodium persulfate.

31. The method of claim 25, wherein said ammonium polymer comprises DADMAC.

32. The method of claim 31, wherein said DADMAC is formed by sodium persulfate.

33. The method of claim 25, wherein said pH is obtained by adding hydrobromic acid.

34. The method of claim 25, wherein said pH is obtained by adding hydrochloric acid.

35. The method of claim 25, wherein said pH is 4.25±0.25.

36. The method of claim 25, wherein said ammonium polymer is formed by the condensation reaction of epichlorhydrin with an amine.

37. The method of claim 36, wherein said ammonium polymer is an Epi-DMA.

38. The method of claim 36, wherein said ammonium polymer reaction is stopped by adding an acid not comprising sulfur.

39. The method of claim 38, wherein said acid is hydrochloric acid.

40. The method of claim 25, wherein said acrylamide polymer comprises cationic polyacrylamide.

41. The method of claim 25, wherein said acrylamide polymer comprises non-ionic polyacrylamide.

42. The composition of claim 25, further adding an aluminum salt, excluding alum, after said aluminum polymer.

43. The method of claim 42, wherein the basicity is below 55 percent.

44. The method of claim 42, wherein the basicity is below 45 percent.

45. The method of claim 25, further performing high shear mixing during combination of any aluminum containing chemical.

46. The method of claim 25, wherein said blend is a coagulant.

47. The method of claim 25, further adding water.
